(19) United States
(12) Patent Application Publication
(10) Pub. No.: US 2025/0048151 A1
(43) Pub. Date: Feb. 6, 2025

(54) MEASUREMENT PROCEDURES FOR TRAINING OF PREDICTIVE BEAM MANAGEMENT MODELS

(71) Applicant: QUALCOMM Incorporated, San Diego, CA (US)

(72) Inventors: Jae Ho RYU, San Diego, CA (US); Chu-Hsiang HUANG, San Diego, CA (US); Hari SANKAR, San Diego, CA (US)

(21) Appl. No.: 18/364,951

(22) Filed: Aug. 3, 2023

(51) Int. Cl. H04W 24/10; H04B 17/318; H04L 5/00; H04W 24/08

(52) U.S. Cl. CPC H04W 24/10; H04B 17/328; H04L 5/0048; H04W 24/08

(57) ABSTRACT

Methods, systems, and devices for wireless communications are described. A user equipment (UE) may receive a control message indicating, from multiple sets of resources associated with channel measurement, a first set of resources and a second set of resources. The UE may receive one or more first reference signals of a first set of reference signals via the first set of resources and one or more second reference signals of a second set of reference signals via the second set of resources. The UE may transmit a measurement report, including at least a first measurement associated with at least one of the one or more first reference signals and at least a second measurement associated with at least one of the one or more second reference signals, based on the control message and reception of the one or more first reference signals and the one or more second reference signals.

### FIELD OF TECHNOLOGY

The following relates to wireless communications, including measurement procedures for training of predictive beam management models.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support measurement procedures for a training of predictive beam management models. For example, a network entity may request a user equipment (UE) to measure and report on a first set of reference signals corresponding to a first set of channel measurement resources (CMRs) and a second set of reference signals corresponding to a second set of CMRs and may use measurement results associated with the first set of reference signals and the second set of reference signals to train, refine, or update a predictive beam management model. In some implementations, the network entity may request the UE to measure and report on the first set of reference signals and the second set of reference signals via a single control message, such as via a triggering downlink control information (DCI). Based on receiving the request, the UE may measure the first set of reference signals via the first set of CMRs and the second set of reference signals via the second set of CMRs and may transmit a measurement report (e.g., a channel state information (CSI) report) to the network entity that includes measurements associated with the first set of reference signals and measurements associated with second set of reference signals.

A method for wireless communications by a UE is described. The method may include receiving a control message that indicates, from a set of multiple sets of resources associated with channel measurement, a first set of resources and a second set of resources, where the first set of resources corresponds to a first set of reference signals and the second set of resources corresponds to a second set of reference signals, receiving one or more first reference signals of the first set of reference signals via the first set of resources and one or more second reference signals of the second set of reference signals via the second set of resources, and transmitting a measurement report including at least a first measurement associated with at least one of the one or more first reference signals and at least a second measurement associated with at least one of the one or more second reference signals based on the control message and reception of the one or more first reference signals and the one or more second reference signals.

A UE for wireless communications is described. The UE may include one or more memories storing processor executable code, and one or more processors coupled with the one or more memories. The one or more processors may be individually or collectively operable to execute the code to cause the UE to receive a control message that indicates, from a set of multiple sets of resources associated with channel measurement, a first set of resources and a second set of resources, where the first set of resources corresponds to a first set of reference signals and the second set of resources corresponds to a second set of reference signals, receive one or more first reference signals of the first set of reference signals via the first set of resources and one or more second reference signals of the second set of reference signals via the second set of resources, and transmit a measurement report including at least a first measurement associated with at least one of the one or more first reference signals and at least a second measurement associated with at least one of the one or more second reference signals based on the control message and reception of the one or more first reference signals and the one or more second reference signals.

Another UE for wireless communications is described. The UE may include means for receiving a control message that indicates, from a set of multiple sets of resources associated with channel measurement, a first set of resources and a second set of resources, where the first set of resources corresponds to a first set of reference signals and the second set of resources corresponds to a second set of reference signals, means for receiving one or more first reference signals of the first set of reference signals via the first set of resources and one or more second reference signals of the second set of reference signals via the second set of resources, and means for transmitting a measurement report including at least a first measurement associated with at least one of the one or more first reference signals and at least a second measurement associated with at least one of the one or more second reference signals based on the control message and reception of the one or more first reference signals and the one or more second reference signals.

A non-transitory computer-readable medium storing code for wireless communications is described. The code may include instructions executable by one or more processors to receive a control message that indicates, from a set of multiple sets of resources associated with channel measurement, a first set of resources and a second set of resources, where the first set of resources corresponds to a first set of reference signals and the second set of resources corresponds to a second set of reference signals, receive one or more first reference signals of the first set of reference signals via the first set of resources and one or more second reference signals of the second set of reference signals via the second set of resources, and transmit a measurement report including at least a first measurement associated with at least one of the one or more first reference signals and at least a second measurement associated with at least one of the one or more second reference signals based on the control message and reception of the one or more first reference signals and the one or more second reference signals.

In some examples of the method, UEs, and non-transitory computer-readable medium described herein, receiving the control message may include operations, features, means, or instructions for receiving a DCI message that includes an indication of a CSI report setting, the CSI report setting including a first parameter that indicates the first set of resources and a second parameter that indicates the second set of resources.

In some examples of the method, UEs, and non-transitory computer-readable medium described herein, receiving the control message may include operations, features, means, or instructions for receiving a DCI message that includes an indication of a CSI report setting, the CSI report setting including one or more parameters that indicate one or more serving cells associated with the first set of resources and the second set of resources.

In some examples of the method, UEs, and non-transitory computer-readable medium described herein, the one or more parameters may include a single parameter that indicates that the first set of resources and the second set of resources correspond to a same serving cell, and receiving the one or more first reference signals and the one or more second reference signals may include operations, features, means, or instructions for receiving the one or more first reference signals and the one or more second reference signals via the same serving cell.

In some examples of the method, UEs, and non-transitory computer-readable medium described herein, the one or more parameters may include a single parameter that indicates that the first set of resources and the second set of resources correspond to a same serving cell, and receiving the one or more first reference signals and the one or more second reference signals may include operations, features, means, or instructions for receiving the one or more first reference signals via a first serving cell and receiving the one or more second reference signals via a second serving cell.

Some examples of the method, UEs, and non-transitory computer-readable medium described herein may further include operations, features, means, or instructions for receiving an indication of the one or more first reference signals or the one or more second reference signals, the one or more first reference signals or the one or more second reference signals being a subset of the first set of reference signals or the second set of reference signals, respectively.

Some examples of the method, UEs, and non-transitory computer-readable medium described herein may further include operations, features, means, or instructions for receiving an indication of a single receive beam associated with measurement of each reference signal of the one or more first reference signals and each reference signal of the one or more second reference signals and measuring the one or more first reference signals and the one or more second reference signals using the single receive beam, where at least the first measurement and at least the second measurement may be based on using the single receive beam.

Some examples of the method, UEs, and non-transitory computer-readable medium described herein may further include operations, features, means, or instructions for receiving an indication of a first receive beam associated with measurement of each reference signal of the one or more first reference signals and a second receive beam associated with measurement of each reference signal of the one or more second reference signals, measuring the one or more first reference signals using the first receive beam to generate the first measurement, and measuring the one or more second reference signals using the second receive beam to generate the second measurement.

In some examples of the method, UEs, and non-transitory computer-readable medium described herein, switching, during a time duration between the first set of resources and the second set of resources, from the first receive beam to the second receive beam based on the first receive beam being associated with the measurement of each reference signal of the one or more first reference signals and the second receive beam being associated with the measurement of each reference signal of the one or more second reference signals.

Some examples of the method, UEs, and non-transitory computer-readable medium described herein may further include operations, features, means, or instructions for transmitting an indication of a minimum time duration associated with a beam switching capability of the UE, where the time duration between the first set of resources and the second set of resources may be greater than or equal to the minimum time duration.

Some examples of the method, UEs, and non-transitory computer-readable medium described herein may further include operations, features, means, or instructions for receiving a request for measurement reporting of each of the first set of reference signals and each of the second set of reference signals, where the measurement report includes a set of measurements that correspond to the first set of reference signals and the second set of reference signals.

In some examples of the method, UEs, and non-transitory computer-readable medium described herein, the measurement report may include operations, features, means, or instructions for an absolute measurement that corresponds to a reference signal, of the first set of reference signals or the second set of reference signals, associated with a highest RSRP measurement, a resource index that corresponds to the reference signal associated with the highest RSRP measurement, and differential measurements, relative to the absolute measurement, for each of a remainder of the first set of reference signals and the second set of reference signals.

Some examples of the method, UEs, and non-transitory computer-readable medium described herein may further include operations, features, means, or instructions for receiving a request for measurement reporting of a first subset of the first set of reference signals and a second subset of the second set of reference signals, where the measurement report includes a first set of measurements that correspond to the first subset of the first set of reference signals and a second set of measurements that correspond to the second subset of the second set of reference signals, and where the one or more first reference signals include the first subset and the one or more second reference signals include the second subset.

In some examples of the method, UEs, and non-transitory computer-readable medium described herein, the measurement report may include operations, features, means, or instructions for first resource indices that correspond to the first subset of the first set of reference signals, an absolute measurement that corresponds to a reference signal, of the first subset of the first set of reference signals, associated with a highest RSRP measurement, first differential measurements, relative to the absolute measurement, for each of a remainder of the first subset of the first set of reference signals, second resource indices that correspond to the second subset of the second set of reference signals, and second differential measurements, relative to the absolute measurement, for each of the second subset of the second set of reference signals.

A method for wireless communications by a network entity is described. The method may include transmitting a control message that indicates, from a set of multiple sets of resources associated with channel measurement, a first set of resources and a second set of resources, where the first set of resources corresponds to a first set of reference signals and the second set of resources corresponds to a second set of reference signals, transmitting the first set of reference signals via the first set of resources and the second set of reference signals via the second set of resources, and receiving a measurement report including at least a first measurement associated with at least one of the first set of reference signals and at least a second measurement associated with at least one of the second set of reference signals based on the control message and transmission of the first set of reference signals and the second set of reference signals.

A network entity for wireless communications is described. The network entity may include one or more memories storing processor executable code, and one or more processors coupled with the one or more memories. The one or more processors may be individually or collectively operable to execute the code to cause the network entity to transmit a control message that indicates, from a set of multiple sets of resources associated with channel measurement, a first set of resources and a second set of resources, where the first set of resources corresponds to a first set of reference signals and the second set of resources corresponds to a second set of reference signals, transmit the first set of reference signals via the first set of resources and the second set of reference signals via the second set of resources, and receive a measurement report including at least a first measurement associated with at least one of the first set of reference signals and at least a second measurement associated with at least one of the second set of reference signals based on the control message and transmission of the first set of reference signals and the second set of reference signals.

Another network entity for wireless communications is described. The network entity may include means for transmitting a control message that indicates, from a set of multiple sets of resources associated with channel measurement, a first set of resources and a second set of resources, where the first set of resources corresponds to a first set of reference signals and the second set of resources corresponds to a second set of reference signals, means for transmitting the first set of reference signals via the first set of resources and the second set of reference signals via the second set of resources, and means for receiving a measurement report including at least a first measurement associated with at least one of the first set of reference signals and at least a second measurement associated with at least one of the second set of reference signals based on the control message and transmission of the first set of reference signals and the second set of reference signals.

A non-transitory computer-readable medium storing code for wireless communications is described. The code may include instructions executable by one or more processors to transmit a control message that indicates, from a set of multiple sets of resources associated with channel measurement, a first set of resources and a second set of resources, where the first set of resources corresponds to a first set of reference signals and the second set of resources corresponds to a second set of reference signals, transmit the first set of reference signals via the first set of resources and the second set of reference signals via the second set of resources, and receive a measurement report including at least a first measurement associated with at least one of the first set of reference signals and at least a second measurement associated with at least one of the second set of reference signals based on the control message and transmission of the first set of reference signals and the second set of reference signals.

In some examples of the method, network entities, and non-transitory computer-readable medium described herein, transmitting the control message may include operations, features, means, or instructions for transmitting a DCI message that includes an indication of a CSI report setting, the CSI report setting including a first parameter that indicates the first set of resources and a second parameter that indicates the second set of resources.

In some examples of the method, network entities, and non-transitory computer-readable medium described herein, transmitting the control message may include operations, features, means, or instructions for transmitting a DCI message that includes an indication of a CSI report setting, the CSI report setting including one or more parameters that indicate one or more serving cells associated with the first set of resources and the second set of resources.

In some examples of the method, network entities, and non-transitory computer-readable medium described herein, the one or more parameters may include a single parameter that indicates that the first set of resources and the second set of resources correspond to a same serving cell, and transmitting the first set of reference signals and the second set of reference signals may include operations, features, means, or instructions for transmitting the first set of reference signals and the second set of reference signals via the same serving cell.

In some examples of the method, network entities, and non-transitory computer-readable medium described herein, the one or more parameters may include a single parameter that indicates that the first set of resources and the second set of resources correspond to a same serving cell, and transmitting the first set of reference signals and the second set of reference signals may include operations, features, means, or instructions for transmitting the first set of reference signals via a first serving cell and transmitting the second set of reference signals via a second serving cell.

Some examples of the method, network entities, and non-transitory computer-readable medium described herein may further include operations, features, means, or instructions for transmitting an indication of one or more first reference signals of the first set of reference signals or one or more second reference signals of the second set of reference signals, the one or more first reference signals or the one or more second reference signals being a subset of the first set of reference signals or the second set of reference signals, respectively and receiving, via the measurement report, a set of measurements associated with one or both of the one or more first reference signals or the one or more second reference signals.

Some examples of the method, network entities, and non-transitory computer-readable medium described herein may further include operations, features, means, or instructions for transmitting an indication of a single receive beam associated with measurement of each reference signal of the first set of reference signals and each reference signal of the second set of reference signals.

Some examples of the method, network entities, and non-transitory computer-readable medium described herein may further include operations, features, means, or instructions for transmitting an indication of a first receive beam associated with measurement of the first set of reference signals and a second receive beam associated with measurement of the second set of reference signals.

Some examples of the method, network entities, and non-transitory computer-readable medium described herein may further include operations, features, means, or instructions for receiving an indication of a minimum time duration associated with a beam switching capability of a UE, where a time duration between the first set of resources and the second set of resources may be greater than or equal to the minimum time duration.

Some examples of the method, network entities, and non-transitory computer-readable medium described herein may further include operations, features, means, or instructions for transmitting a request for measurement reporting of each of the first set of reference signals and each of the second set of reference signals, where the measurement report includes a set of measurements that correspond to the first set of reference signals and the second set of reference signals.

In some examples of the method, network entities, and non-transitory computer-readable medium described herein, the measurement report may include operations, features, means, or instructions for an absolute measurement that corresponds to a reference signal, of the first set of reference signals or the second set of reference signals, associated with a highest RSRP measurement, a resource index that corresponds to the reference signal associated with the highest RSRP measurement, and differential measurements, relative to the absolute measurement, for each of a remainder of the first set of reference signals and the second set of reference signals.

Some examples of the method, network entities, and non-transitory computer-readable medium described herein may further include operations, features, means, or instructions for transmitting a request for measurement reporting of a first subset of the first set of reference signals and a second subset of the second set of reference signals, where the measurement report includes a first set of measurements that correspond to the first subset of the first set of reference signals and a second set of measurements that correspond to the second subset of the second set of reference signals.

In some examples of the method, network entities, and non-transitory computer-readable medium described herein, the measurement report may include operations, features, means, or instructions for first resource indices that correspond to the first subset of the first set of reference signals, an absolute measurement that corresponds to a reference signal, of the first subset of the first set of reference signals, associated with a highest RSRP measurement, first differential measurements, relative to the absolute measurement, for each of a remainder of the first subset of the first set of reference signals, second resource indices that correspond to the second subset of the second set of reference signals, and second differential measurements, relative to the absolute measurement, for each of the second subset of the second set of reference signals.

Some examples of the method, network entities, and non-transitory computer-readable medium described herein may further include operations, features, means, or instructions for training a machine learning model configured to predict spatial-domain characteristics associated with the second set of reference signals based on at least the first measurement and at least the second measurement and selecting a downlink beam for communication with a UE based on an output of the machine learning model.

Some examples of the method, network entities, and non-transitory computer-readable medium described herein may further include operations, features, means, or instructions for receiving measurement information associated with at least a subset of the first set of reference signals, inputting the measurement information into the machine learning model, and obtaining, as an output of the machine learning model, predicted spatial-domain characteristics associated with the second set of reference signals, where selecting the downlink beam may be based on the predicted spatial-domain characteristics.

### BRIEF DESCRIPTION OF THE DRAWINGS

FIG. 1 shows an example of a wireless communications system that supports measurement procedures for training of predictive beam management models in accordance with one or more aspects of the present disclosure.

FIG. 2 shows an example of a wireless communications system that supports measurement procedures for training of predictive beam management models in accordance with one or more aspects of the present disclosure.

FIGS. 3 through 5 show examples of signaling diagrams that support measurement procedures for training of predictive beam management models in accordance with one or more aspects of the present disclosure.

FIG. 6 shows an example of a process flow that supports measurement procedures for training of predictive beam management models in accordance with one or more aspects of the present disclosure.

FIGS. 7 and 8 show block diagrams of devices that support measurement procedures for training of predictive beam management models in accordance with one or more aspects of the present disclosure.

FIG. 9 shows a block diagram of a communications manager that supports measurement procedures for training of predictive beam management models in accordance with one or more aspects of the present disclosure.

FIG. 10 shows a diagram of a system including a device that supports measurement procedures for training of predictive beam management models in accordance with one or more aspects of the present disclosure.

FIGS. 11 and 12 show block diagrams of devices that support measurement procedures for training of predictive beam management models in accordance with one or more aspects of the present disclosure.

FIG. 13 shows a block diagram of a communications manager that supports measurement procedures for training of predictive beam management models in accordance with one or more aspects of the present disclosure.

FIG. 14 shows a diagram of a system including a device that supports measurement procedures for training of predictive beam management models in accordance with one or more aspects of the present disclosure.

FIGS. 15 through 17 show flowcharts illustrating methods that support measurement procedures for training of predictive beam management models in accordance with one or more aspects of the present disclosure.

### DETAILED DESCRIPTION

Various aspects relate generally to wireless communication and more particularly to beam management. Some aspects more specifically relate to beam measurement procedures for data collection and training of predictive beam management models. In some examples, a user equipment (UE) and a network entity may employ a multi-reference signal set measurement procedure to support data collection for an artificial intelligence (AI) or machine learning (ML) beam management model at the network entity. For example, an AI/ML beam management model may use measurements of a first set of reference signals (which may be associated with a set B of beams) to predict characteristics (e.g., signal strengths, signal-to-noise ratios (SNRs), reference signal receive powers (RSRPs), etc.) of a second set of reference signals (which may be associated with a set A of beams) and, to support a collection of relevant data for such a prediction, the network entity may trigger the UE to measure multiple different sets of reference signals via a single control message. Such a triggering (or activation) of multiple different sets of reference signals for measurement by the UE via a single control message may enable the UE to measure (such as via one or more antennas and/or processors of the UE) the multiple sets of reference signals in short succession, which may provide more relevant training data for the AI/ML model (as a likelihood of channel variation across the measurements of the multiple different sets is reduced).

In some implementations, the network entity may trigger the UE to measure the multiple different sets of reference signals via a triggering downlink control information (DCI) message. In such implementations, the DCI message may trigger or indicate a channel state information (CSI) report configuration (e.g., a CSI report setting) that indicates at least a first set of reference signals corresponding to a first set of channel measurement resources (CMRs) and a second set of reference signals corresponding to a second set of CMRs. The CSI report configuration may include a first parameter indicative of the first set of CMRs and a second parameter indicative of the second set of CMRs. In some aspects, the CSI report configuration may further include one or more additional parameters indicative of one or more serving cells via which the first set of reference signals and the second set of reference signals are to be transmitted to the UE.

Particular aspects of the subject matter described in this disclosure can be implemented to realize one or more of the following potential advantages. By utilizing a single triggering control message (e.g., a single DCI message) that requests measurement of multiple sets of reference signals, aspects of the present disclosure may increase accuracy and reliability of AI/ML-based beam prediction. More specifically, by enabling measurements of multiple different sets of reference signals at UEs in short succession, the network may obtain more relevant and higher quality training data, which may support greater accuracy and reduced latency associated with beam prediction using an AI/ML model. Further, by indicating one or more serving cells via which different sets of reference signals are to be transmitted to the UE, aspects of the present disclosure may enable per-cell training or fine tuning of an AI/ML model, which may increase a flexibility of beam management procedures. For example, by training or fine tuning the AI/ML model per-cell, the network may adapt spatial beam prediction across serving cells to support greater accuracy and greater versatility of beam management procedures. In accordance with such increased accuracy, reduced latency, and increased flexibility, the described techniques may be further implemented to support higher data rates, greater system capacity, and greater spectral efficiency, among other benefits.

Aspects of the disclosure are initially described in the context of wireless communications systems. Aspects of the disclosure are further described in the context of signaling diagrams and process flows. Aspects of the disclosure are further illustrated by and described with reference to apparatus diagrams, system diagrams, and flowcharts that relate to measurement procedures for training of predictive beam management models.

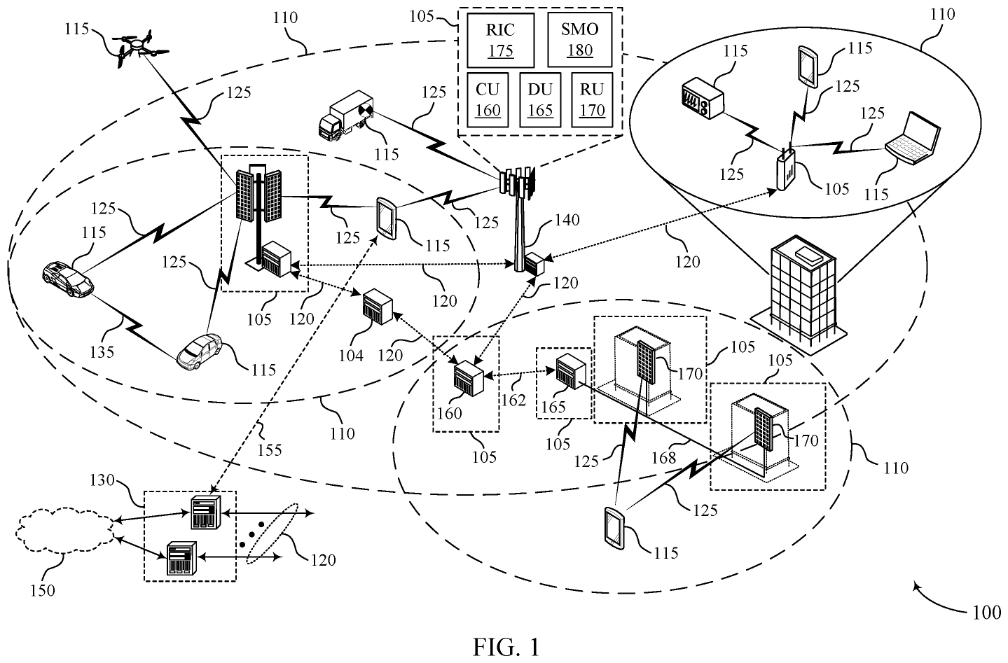

FIG. 1 shows an example of a wireless communications system 100 that supports measurement procedures for training of predictive beam management models in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as L1 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support measurement procedures for training of predictive beam management models as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support various communication procedures. A UE 115 may start in an RRC idle state or an RRC inactive state. The UE 115 may perform an initial access with a network entity 105. The initial access may include SSBs, beam sweeping, contention-based random access (CBRA), RACH procedures (e.g., occasions, preambles), or any combination thereof. The UE 115 and the network entity 105 in an RRC connected state, based on a successful initial access, may perform beam management procedures. For example, beam management procedures may support L1 signal to interference plus noise ratio (SINR) reporting, L1 RSRP reporting, overhead and latency reduction (e.g., component carrier aggregation group beam update, efficient UL beam update), latency and efficiency enhancements (e.g., unified transmission configuration indicator (TCI) states, L1 and L2-centric mobility, dynamic TCI update, UL multi-panel selection, maximum power extrapolation (MPE) mitigation, or any combination thereof.

In the RRC connected state, the UE 115 may perform beam failure detection based on channel quality measurements or beam measurements. Based on detecting one or more failed beams, the UE 115 may perform beam failure recovery. For example, the UE 115 may perform beam failure detection, beam failure recovery, or both, for primary cells (PCells), primary and secondary cells (PSCells), or secondary cells (SCells) using reference signals, physical DL control channel (PDCCH) block error rate (BLER), contention-free random access (FRA), link recovery requests, MAC-control element (MAC-CE), or any combination thereof. In some cases, the UE 115 may perform fast recovery and restart beam management procedures. In other cases, the UE 115 may determine a radio link failure.

The wireless communications system 100 may support beam management, beam prediction in time, spatial domain for overhead and latency reduction, beam selection accuracy improvement, or any combination thereof. In some cases, the wireless communications system 100 may utilize AI or ML techniques. UEs 115 and network entities 105 in the wireless communications system 100 may perform model training, model deployment, model inference, model monitoring, model updating, or a combination thereof, on an AI or ML model to assist in wireless communications methods and protocols.

In some examples of beam management (e.g., AI-based or ML-based beam management), the network entity 105 may configure the UE 115 with two sets of beams for CSI measurement and prediction. For example, the network entity may configure the UE 115 with a first set of beams (e.g., a set A of beams) and a second set of beams (e.g., a set B of beams) and the network entity 105 (or the UE 115) may use an AI/ML model to support spatial domain downlink beam prediction (and, in some cases, temporal downlink beam prediction) of the first set of beams based on measurement results of the second set of beams. For example, a wireless communication device (such as a network entity 105 or a UE 115) may use an AI/ML model to perform a beam prediction for the first set of beams based on measurement results, historic measurement results, or a combination thereof, of the second set of beams. In some cases, the wireless communication device may use a second set of resources (e.g., CMRs, virtual resources) to perform the beam prediction, and the second set of resources may correspond to the first set of beams. The first set of beams and the second set of beams may be in the same frequency range or in different frequency ranges (e.g., the first set of resources and the second set of resources may partially overlap in frequency, completely overlap in frequency, may correspond to adjacent frequency ranges or frequency bands or subbands, or may be entirely different from each other).

In some examples, the second set of beams may be a subset of the first set of beams. In some examples, the first set of beams may have a same quantity of beams as the second set of beams, or the sets of beams (e.g., set A, set B) may have different quantities of beams. In some cases, the first set of beams may be associated with the second set of beams based on a fixed pattern, a random pattern, or a quasi-colocation relationship. The first set of beams may have different characteristics than the second set of beams. For example, the second set of beams may be wide (e.g., coarse) beams and the first set of beams may be narrow (e.g., fine) beams. In some examples, subsets of the second set of beams may correspond to individual coarse beams of the first set of beams (e.g., three narrow beams of the first set of beams may correspond to each coarse beam of the second set of beams). The second set of beams may be for DL beam measurement, and the first set of beams may be for DL beam prediction. The first set of beams and the second set of beams may be indicated by or associated with one or more codebook constructions.

In some examples, a UE 115 may receive, from a network entity 105, a control message that indicates, from multiple sets of CMRs, a first set of CMRs and a second set of CMRs. The first set of CMRs may correspond to a first set of reference signals (e.g., reference signals associated with a set A of beams, among other examples) and the second set of CMRs may correspond to a second set of reference signals (e.g., reference signals associated with a set B of beams, among other examples). The UE 115 may receive, from the network entity 105, one or more first reference signals of the first set of reference signals via the first set of CMRs and one or more second reference signals of the second set of reference signals via the second set of CMRs. The UE 115 may transmit, to the network entity 105, a measurement report including at least a first measurement associated with at least one of the one or more first reference signals and at least a second measurement associated with at least one of the one or more second reference signals. The UE 115 may transmit the measurement report based on the control message and reception of the one or more first reference signals and the one or more second reference signals.

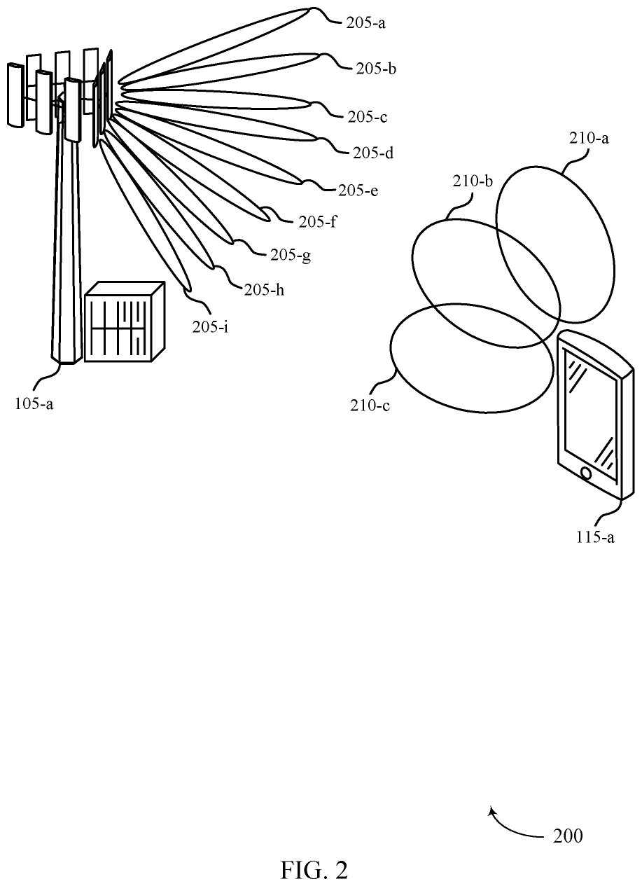

FIG. 2 shows an example of a wireless communications system 200 that supports measurement procedures for training of predictive beam management models in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices as described herein with reference to FIG. 1.

The UE 115-a and the network entity 105-a may refine transmit beams of the network entity 105-a or receive beams of the UE 115-a as part of one or more beam management procedures. The one or more beam management procedures may include a Procedure 1 (P1), a Procedure 2 (P2), a Procedure 3 (P3), or any combination thereof. The P1 may be performed by the network entity 105-a and the UE 115-a to select an SSB from a set of SSBs with the highest RSRP. The network entity 105-a may sweep SSBs through a set of candidate SSBs. The set of candidate SSBs may include a beam 205-a, a beam 205-b, a beam 205-c, a beam 205-d, a beam 205-e, a beam 205-f, a beam 205-g, a beam 205-h, and a beam 205-i. The UE 115-a may measure one or more of the SSBs and may transmit a measurement report to the network entity that includes measurements, such as RSRP measurements, for the one or more SSBs. To measure the SSBs, the UE 115-a may sweep through a set of candidate receive beams (e.g., a beam 210-a, a beam 210-b, a beam 210-c). The UE 115-a may select a receive beam (e.g., the beam 210-b) based on the measurements obtained from each of the candidate receive beams to be used for communication with the network entity 105-a. For example, the UE 115-a may select the receive beam associated with the highest RSRP relative to other RSRPs that the UE 115-a measures.

The P2 may be performed by the network entity 105-a to select a transmit beam from the set of candidate transmit beams for communications with the UE. The network entity 105-a may request, from the UE 115-a, aperiodic measurement of SSB reference signals or of CSI-RSs via DCI. The network entity 105-a may sweep the SSB reference signals or the CSI-RSs through a set of candidate transmit beams. The UE 115-a may perform measurements on the set of candidate transmit beams and may report the measurements to the network entity. The network entity 105-a may select the transmit beam (e.g., the beam 205-e) based on the reported measurements from the UE 115-a.

The P3 may be performed by the UE 115-a to select a receive beam from the set of candidate receive beams 210 based on aperiodic measurement of CSI-RSs. The network entity 105-a may select a transmit beam and indicate quasi-colocation information associated with the selected transmit beam to the UE 115-a. CSI-RS resources in a slot may have the same beam configuration for the network entity 105-a. The UE 115-a may perform measurements on the CSI-RSs, such as an RSRP, and may select a receive beam based on the measurements.

In some examples, the network entity 105-a may use AI or ML-based spatial beam prediction. For example, the network entity 105-a may predict a measurement for a CSI-RS based on a measurement of an SSB, or vice versa. In other examples, the network entity 105-a may predict a measurement for a first beam (e.g., a narrow beam) based on measurement results for a second beam (e.g., a wide beam). The network entity 105-a may predict spatial characteristics (e.g., shape, size, width, signal strength, SNR, RSRP, etc.) of the first beam using the measurement results of the second beam.

In some examples, the network entity 105-a may train a predictive model based on historic measurement results of reference signals or beams. The predictive model may be an ML model, an AI model, a pre-trained model, a reinforcement learning model, a federated learning model, or any other model capable of taking inputs and outputting a prediction based on previously supplied training data. In some cases, to improve accuracy, the network entity 105-a may perform per-cell training of the predictive (e.g., ML/AI) model. That is, outputs of the predictive model may be based on the cell over which the network entity 105-a communicates with the UE 115-a. Per-cell training or fine-tuning of the predictive model may be beneficial, for example, because shapes of transmit beams 205 at the network entity 105-a may have per-cell variation due to variations in implementation. Additionally, or alternatively, the UE 115-a may observe beams and identify or measure inter-beam correlation, but such correlation may be affected by a scattering environment, which may vary across cells.

The UE 115-a may measure transmit beams of the network entity 105-a in accordance with an L1-RSRP measurement procedure, and the UE 115-a may report measurements to the network entity 105-a. The network entity 105-a may train the predictive model using the reported measurements from the UE 115-a. However, the data (e.g., measurements) that the network entity 105-a collects using the L1-RSRP measurement procedure with the UE 115-a may be insufficient for per-cell training of the predictive model for beam management. Further, the UE 115-a may not measure transmit (e.g., downlink) beams for set A beams and set B beams at the same time. The set A beams may include narrow or refined beams (e.g., CSI-RS beams, beams after fine tuning). The set B beams may include coarse or wide beams (e.g., SSB beams, beams before fine tuning). Additionally, a receive beam used by the UE 115-a to measure different transmit beams of the network entity 105-a may not be aligned as, in some systems, it may be preferable to measure different downlink reference signals (e.g., different SSBs or CSI-RSs) with different receive beams of the UE 115-a, each receive beam refined separately for each downlink reference signal.

In accordance with the examples described herein, the network entity 105-a may transmit a triggering DCI to the UE 115-a indicating CMRs that correspond to reference signals of the set A beams and CMRs that correspond to reference signals of the set B beams (or any other two reference signals sets corresponding to two different sets of beams at the network entity 105-a). The UE 115-a may receive one or more reference signals of set A and one or more reference signals of set B, and the UE 115-a may transmit a measurement report (e.g., a CSI report) including at least a first measurement associated with at least one of the one or more reference signals of set A and at least a second measurement associated with at least one of the one or more reference signals of set B. In some examples, to indicate the reference signals of set A and the reference signals of set B to the UE 115-a, the triggering DCI may indicate a CSI report configuration (e.g., a CSI report setting) that includes a first parameter to indicate the CMRs corresponding to the set A reference signals and a second parameter to indicate the CMRs corresponding to the set B reference signals. Further, although the two sets of reference signals are described herein as a set A of reference signals and a set B of reference signals, each of the two sets of reference signals may be any set of reference signals and may not be limited to one set that is sometimes used for beam measurement and another set that is sometimes used for beam prediction.

By receiving the measurement report that includes measurements associated with both set A and set B reference signals, the network entity 105-a may perform per-cell fine tuning of the predictive model, which may increase accuracy or reliability of AI or ML-based spatial beam prediction. For example, the network entity 105-a may train an ML model configured to predict spatial-domain characteristics (e.g., signal strengths, SNRs, RSRPs, etc.) associated with the set A reference signals based on the first measurement and the second measurement. In some cases, the network entity 105 may receive measurement information associated with at least a subset of the set B reference signals, may input the measurement into the ML model, and may obtain, as an output of the ML model, predicted spatial-domain characteristics associated with the set A reference signals. The network entity 105 may select a downlink beam for communication with the UE 115-a based on the output of the ML model.

Further, for the purposes of spatial beam prediction, it may be beneficial for the network entity 105-a to control selection of a receive beam that the UE 115-a uses to measure transmit beams (e.g., reference signals) of the network entity 105-a. Thus, in some examples, the network entity 105-a may indicate a UE receive beam constraint that applies to measurement of set A reference signals and set B reference signals at the UE 115-a. The UE receive beam constraint may indicate that the UE 115-a is to use (or is expected to use) a common (e.g., a single or same) receive beam for measurement of reference signals of the set A beams and reference signals of the set B or may indicate that the UE 115-a is to use (or is expected to use) separate receive beams for measurement of reference signals of the set A beams and reference signals of the set B beams.

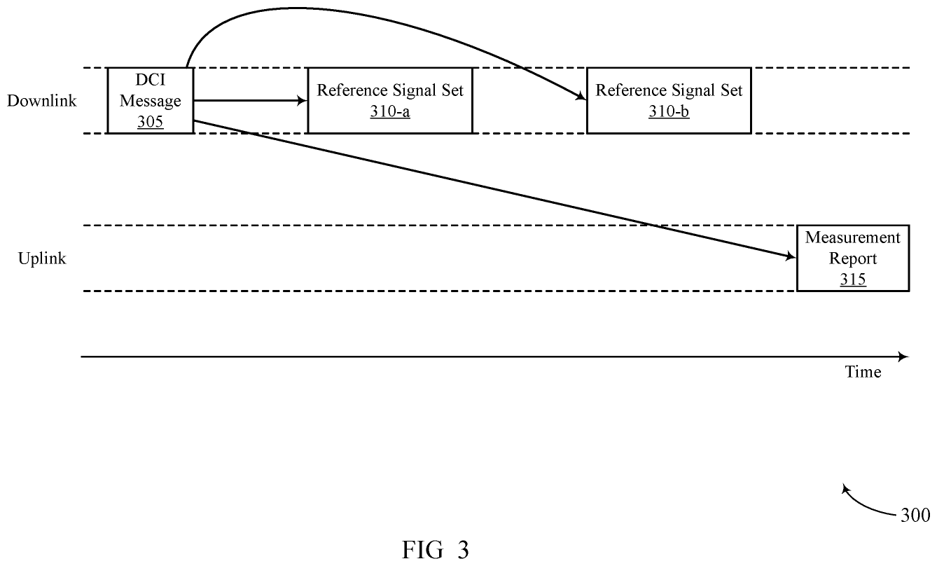

FIG. 3 shows an example of a signaling diagram 300 that supports measurement procedures for training of predictive beam management models in accordance with one or more aspects of the present disclosure. The signaling diagram 300 may implement or may be implemented by aspects of the wireless communications system 100 or the wireless communications system 200. For example, the signaling diagram 300 may include a DCI message 305, a reference signal set 310-a, a reference signal set 310-b, and a measurement report 315, which may be examples of signals communicated between a UE 115 and a network entity 105, as described herein with reference to FIGS. 1 and 2.

The network entity 105 may transmit a DCI message 305 via a PDCCH. The DCI message 305 may indicate (e.g., request) the UE 115 to measure reference signals of multiple reference signal sets 310 and to transmit a measurement report 315 (e.g., in accordance with aperiodic L1-RSRP reporting) including measurements associated with the reference signal set 310-a and the reference signal set 310-b. The DCI message 305 may indicate a first set of resources (e.g., CMRs) corresponding to the reference signal set 310-a and a second set of resources corresponding to the reference signal set 310-b. The UE 115 may receive the reference signal set 310-a via the first set of resources and may receive the reference signal set 310-b via the second set of resources. In some examples, the network entity 105 may use data (e.g., measurements) received via the measurement report 315 for beam management data collection.

The reference signal set 310-a and the reference signal set 310-b may include any permutation of CSI-RSs and/or SSBs. In some examples, the reference signal set 310-a may include CSI-RSs and the reference signal set 310-b may include SSBs, or vice versa. Alternatively, the reference signal set 310-a may include SSBs and the reference signal set 310-b may include SSBs. Alternatively, the reference signal set 310-a may include CSI-RSs and the reference signal set 310-b may include CSI-RSs. In some cases, the reference signal set 310-a may include relatively wider beams (e.g., SSBs) compared with the reference signal set 310-b, which may include relatively narrower beams (e.g., CSI-RSs), or vice versa. In some implementations, the network entity 105 may transmit the reference signal set 310-a and the reference signal set 310-b via a same serving cell. In such implementations, the reference signal set 310-a and the reference signal set 310-b may support same cell wide beam to narrow beam prediction, wide beam to wide beam prediction, or narrow beam to narrow beam prediction.

In some cases, the DCI message 305 may be a triggering DCI and may indicate (e.g., trigger) a CSI report configuration (e.g., a CSI report setting). The CSI report configuration may include a first parameter (e.g., resourceForChannelMeasurement) that indicates the first set of resources corresponding to the reference signal set 310-a and may include a second parameter (e.g., resourceForChannelMeasurment2) that indicates the second set of resources corresponding to the reference signal set 310-b. Accordingly, the network entity 105 may indicate the reference signal set 310-a and the reference signal set 310-b via a same CSI report configuration. The CSI report configuration may also include a third parameter (e.g., carrier) that indicates that the first set of resources and the second set of resources correspond to a same serving cell. For example, in accordance with the CSI report configuration including a single parameter indicative of a serving cell, the UE 115 may assume or expect that the first set of resources and the second set of resources correspond to a same serving cell (e.g., the serving cell indicated by the single carrier parameter).

In some implementations, the network entity 105 may transmit an SSB burst. In such implementations, the reference signal set 310-a or the reference signal set 310-b may include the SSB burst. The SSB burst may include a set of multiple SSBs that are transmitted with beam sweeping. In some examples, the network entity 105 may indicate (e.g., via the DCI message 305) a subset of SSBs (e.g., a subset of the reference signal set 310-a or the reference signal set 310-b) from the set of multiple SSBs for the UE 115 to measure and report on (e.g., via an L1-RSRSP measurement procedure). Accordingly, the UE 115 may receive one or more first reference signals (e.g., a subset of SSBs) of the reference signal set 310-a (e.g., the SSB burst) via the first set of resources or may receive one or more second reference signals of the reference signal set 310-b via the second set of resources. The UE 115 may include measurements of the subset of SSBs in the measurement report 315. For example, the measurement report 315 may include at least a first measurement associated with at least one of the one or more first reference signals (e.g., the subset of SSBs) of the reference signal set 310-a (e.g., the SSB burst). In some cases, the subset of SSBs may be based on a location of the UE 115. For example, for a given UE location, the UE 115 may be able to detect or measure a subset of SSBs within an SSB burst and may be unable to detect or measure a remainder of the SSB burst.

In some examples, the network entity 105 may indicate (e.g., configure) indices for the subset of SSBs. For example, the SSBs may be indexed with reference to a reference SSB (e.g., anchor SSB), and the network entity may indicate indices of SSBs relative to the reference SSB for the UE 115 to measure and report on. The anchor SSB may be the serving SSB for communication between the UE 115 and the network entity 105. In some cases, the network entity 105 may indicate a range of SSB indices for the subset of SSBs, or the network entity 105 may indicate a set of SSB indices that includes each SSB index of the subset of SSBs. Additionally, or alternatively, the network entity 105 may determine the subset of SSBs based on the serving SSB quasi-colocated with a currently active TCI state. The network entity 105 may indicate the subset of SSBs to the UE 115 via RRC signaling or one or more MAC-CEs. Additionally, or alternatively, for L1-RSRP reporting for beam management data collection, the UE 115 may measure and report (e.g., only measure and report) SSB indices within the SSB subset with the serving SSB as the anchor SSB.

In some implementations, the network entity 105 may indicate a UE receive beam constraint for measuring the reference signal set 310-a or the reference signal set 310-b (e.g., for performing L1-RSRP measurement). In some examples, the network entity may transmit an indication of a single receive beam for the UE 115 to use for measurement of any (such as all) reference signals of the reference signal set 310-a and the reference signal set 310-b. For example, the UE 115 may receive an indication of a single receive beam associated with (to be used to measure) each reference signal of the reference signal set 310-a, or a subset of the reference signal set 310-a, and each reference signal of the reference signal set 310-b, or a subset of the reference signal set 310-b. The single receive beam may be associated with or may apply to reception of a same PDCCH message or PDCCH of a same CORESET (e.g., CORESET0). The single receive beam may apply to reception of unicast PDCCH/PDSCH receptions (e.g., a refined beam). In some cases, the single receive beam may apply across receptions or reception types.

In some other examples, the network entity 105 may transmit an indication of separate receive beams for the UE 115 to use for measurement of different reference signals, or for measurement of different reference signal sets 310. For example, the UE 115 may receive an indication of a first receive beam associated with measurement of each reference signal of the reference signal set 310-a, or a subset of the reference signal set 310-a, and a second receive beam associated with measurement of each reference signal of the reference signal set 310-b, or a subset of the reference signal set 310-b. In some cases, the network entity 105 may indicate for the UE 115 to use a per-reference signal receive beam. In such cases, the network entity 105 may indicate that for each reference signal the UE 115 measures and reports, the UE 115 uses a receive beam with a higher RSRP relative to other receive beams (e.g., from a set of candidate receive beams). In other cases, the network entity 105 may indicate for the UE 115 to use separate receive beams for different reference signals, and the UE 115 may select (e.g., autonomously) the receive beam the UE 115 uses for receiving each reference signal such that different reference signals are received via different receive beams.

In some examples, the UE 115 may receive the reference signal set 310-a and the reference signal set 310-b via a same serving cell. In such examples, the network entity 105 may configure the UE 115 to use a common (e.g., a single) beam for measurement of the reference signal set 310-a and the reference signal set 310-b, or the network entity 105 may configure the UE 115 to use a first receive beam for measurement of the reference signal set 310-a and a second receive beam for measurement of the reference signal set 310-b. In some cases, the network entity 105 may configure the UE 115 to use a receive beam with a higher RSRP relative to other receive beams irrespective of whether the reference signal is of the reference signal set 310-a or the reference signal set 310-b.

The network entity 105 may configure a timing relationship between transmission of the DCI message 305 and transmission of the reference signal set 310-a. The reference signal set 310-a may include non-zero power (NZP) CSI-RSs or SSBs. In some examples, the network entity 105 may configure transmission of the reference signal set 310-a to be aperiodic. In such examples, a slot for transmitting the reference signal set 310-a may be based on a triggering offset associated with the reference signal set 310-a. For example, the triggering offset may indicate a quantity of slots between the DCI message 305 and the reference signal set 310-a, and the network entity 105 may indicate the triggering offset to the UE 115 (e.g., via RRC configuration).

In other examples, the network entity 105 may configure transmission of the reference signal set 310-b to be periodic. In such examples, the network entity 105 may transmit the reference signal set 310-b in a slot that is the first reference signal occasion (e.g., first available occasion) after the symbols reserved for PDCCH that contain the DCI message 305. For non-causal measurement, the network entity 105 may use aperiodic transmission of the reference signal set 310-a because the UE receive beam may be different between a first reference signal measurement (e.g., L1-RSRP measurement) and a second reference signal measurement of the reference signal set 310-a (e.g., L1-RSRP measurement for beam management data collection).

In some examples, the network entity 105 may configure (e.g., request) the measurement report 315 to include measurements for any reference signal that the network entity 105 configures. For example, the UE 115 may indicate, via the measurement report 315, measurements of each reference signal of the reference signal set 310-a and each reference signal of the reference signal set 310-b. The measurement report 315 may include an absolute measurement that corresponds to a reference signal, of the reference signal set 310-a or the reference signal set 310-b, with a highest RSRP measurement. The measurement report 315 may also include a resource index that corresponds to the reference signal associated with the highest RSRP measurement. In some cases, the measurement report 315 may include differential measurements, relative to the absolute measurement (e.g., offsets), for each of a remainder of the reference signal set 310-a and the reference signal set 310-b. As described herein, differential measurements may include differential RSRP measurements.

In other examples, the network entity 105 may configure (e.g., request) the measurement report 315 to include measurements for a first subset of the reference signal set 310-a and a second subset of the reference signal set 310-b. The first subset and the second subset may include measurements for the reference signals of the reference signal set 310-a and of the reference signal set 310-b with the highest RSRP (e.g., top-K reference signals) relative to other reference signals of the reference signal set 310-a or the reference signal set 310-b. The network entity 105 may indicate a quantity (e.g., K) of reference signals for each reference signal set 310 to report on via the measurement report 315, and the first subset and the second subset may each include the quantity of reference signals.

The measurement report 315 may include an absolute measurement that corresponds to a reference signal, of the first subset of the reference signal set 310-a, associated with a highest RSRP measurement. In some cases, the measurement report 315 may include a first set of differential measurements, relative to the absolute measurement, for each of a remainder of the first subset (e.g., K−1) of the reference signal set 310-a, and a second set of differential measurements, relative to the absolute measurement, for each of the second subset (e.g., K) of the reference signal set 310-b. The measurement report 315 may also include a first set of resource indices (e.g., SSB indices, CSI-RS indices) that correspond to the reference signal set 310-a and a second set of resource indices that correspond to the reference signal set 310-b.

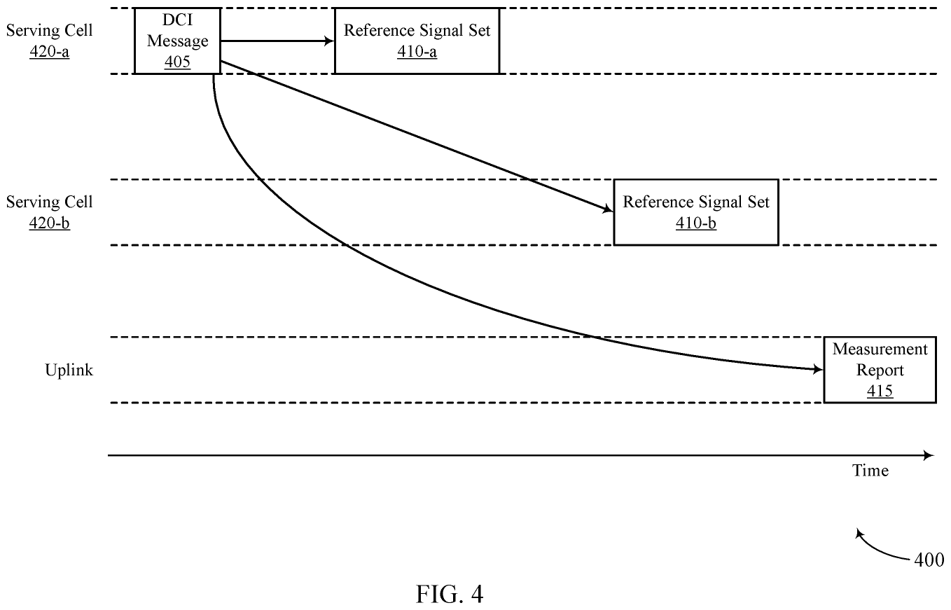

FIG. 4 shows an example of a signaling diagram 400 that supports measurement procedures for training of predictive beam management models in accordance with one or more aspects of the present disclosure. The signaling diagram 400 may implement or may be implemented by aspects of the wireless communications system 100 or the wireless communications system 200. For example, the signaling diagram 400 may include a DCI message 405, a reference signal set 410-a, a reference signal set 410-b, and a measurement report 415, which may be examples of signals communicated between a UE 115 and a network entity 105, as described herein with reference to FIGS. 1 and 2.

The network entity 105 may transmit a DCI message 405 via a PDCCH. The DCI message 405 may indicate (e.g., request) the UE 115 to measure reference signals of multiple reference signal sets 410 and transmit a measurement report 415 (e.g., aperiodic L1-RSRP reporting) including measurements associated with the reference signal set 410-a and the reference signal set 410-b. The DCI message 405 may indicate a first set of resources corresponding to the reference signal set 410-a and a second set of resources corresponding to the reference signal set 410-b. The UE 115 may receive the reference signal set 410-a via the first set of resources and may receive the reference signal set 410-b via the second set of resources. In some examples, the network entity 105 may use data (e.g., measurements) received via the measurement report 415 for beam management data collection.

The reference signal set 410-a may be associated with a serving cell 420-a and may include CSI-RSs or SSBs. The reference signal set 410-b may be associated with a serving cell 420-b and may include CSI-RSs or SSBs. In some cases, the reference signal set 410-a may include relatively wider beams (e.g., SSBs) compared with the reference signal set 410-b, which may include relatively narrower beams (e.g., CSI-RSs), or vice versa. Alternatively, the reference signal set 410-a and the reference signal set 410-b may both include relatively wide beams (e.g., SSBs) or may both include relatively narrow beams (e.g., CSI-RSs). Thus, the reference signal set 410-a and the reference signal set 410-b may support inter-cell wide beam to wide beam prediction, inter-cell wide beam to narrow beam prediction, inter-cell narrow beam to narrow beam prediction, or a combination thereof. The network entity 105 may transmit the reference signal set 410-a via the serving cell 420-a and may transmit the reference signal set 410-b via the serving cell 420-b. The network entity 105 may transmit an indication (e.g., via a CSI report configuration) to the UE 115 that the reference signal set 410-a is associated with the serving cell 420-a and that the reference signal set 410-b is associated with the serving cell 420-b.

In some cases, the DCI message 405 may be a triggering DCI and may indicate (e.g., trigger) a CSI report configuration (e.g., a CSI report setting). The CSI report configuration may include a first parameter (e.g., resourceForChannelMeasurement) that indicates the first set of resources corresponding to the reference signal set 410-a and may include a second parameter (e.g., resourceForChannelMeasurment2) that indicates the second set of resources corresponding to the reference signal set 410-b. Accordingly, the network entity 105 may indicate the reference signal set 410-a and the reference signal set 410-b via a same CSI report configuration. In some examples, the CSI report configuration may include a third parameter (e.g., carrier) that indicates that the first set of resources corresponds to the serving cell 420-a (e.g., a first serving cell) and a fourth parameter (e.g., carrier2) that indicates that the second set of resources corresponds to the serving cell 420-b (e.g., a second serving cell).

Because the network entity 105 transmits the reference signal set 410-a and the reference signal set 410-b via different serving cells 420, the network entity may transmit an indication of separate receive beams for the UE 115 to use for measurement of different reference signals, or for measurement of different reference signal sets 410. For example, the UE 115 may receive an indication of a first receive beam associated with measurement of each reference signal of the reference signal set 410-a, or a subset of the reference signal set 410-a, and a second receive beam associated with measurement of each reference signal of the reference signal set 410-b, or a subset of the reference signal set 410-b. In some cases, the network entity 105 may indicate for the UE 115 to use a per-reference signal receive beam. In such cases, the network entity 105 may indicate that for each reference signal the UE 115 measures and reports, the UE 115 uses a receive beam with a higher RSRP relative to other receive beams (e.g., from a set of candidate receive beams). In other cases, the network entity 105 may indicate for the UE 115 to use separate receive beams for different reference signals, and the UE 115 may select (e.g., autonomously) the receive beam the UE 115 uses for receiving each reference signal such that different reference signals are received via different receive beams.

In some examples, the UE 115 may use a first receive beam for receiving the reference signal set 410-a via the serving cell 420-a, and the network entity 105 may configure the UE 115 with a second receive beam, different from the first receive beam, for measurement of the reference signal set 410-b via the serving cell 420-b. In such cases, the network entity 105 may configure a time duration (e.g., measurement gap, time gap) between transmission of the reference signal set 410-a and transmission of the reference signal set 410-b. The UE 115 may switch, during the time duration, from the first receive beam to the second receive beam. The time duration may be based on a UE capability. For example, the UE 115 may transmit an indication to the network entity 105 of a minimum time duration associated with a beam switching capability of the UE, and the time duration may satisfy (e.g., be greater than or equal to) the minimum time duration. The indication of the minimum time duration may indicate a quantity of OFDM symbols. The UE 115 may use the second receive beam for receiving the reference signal set 410-b.

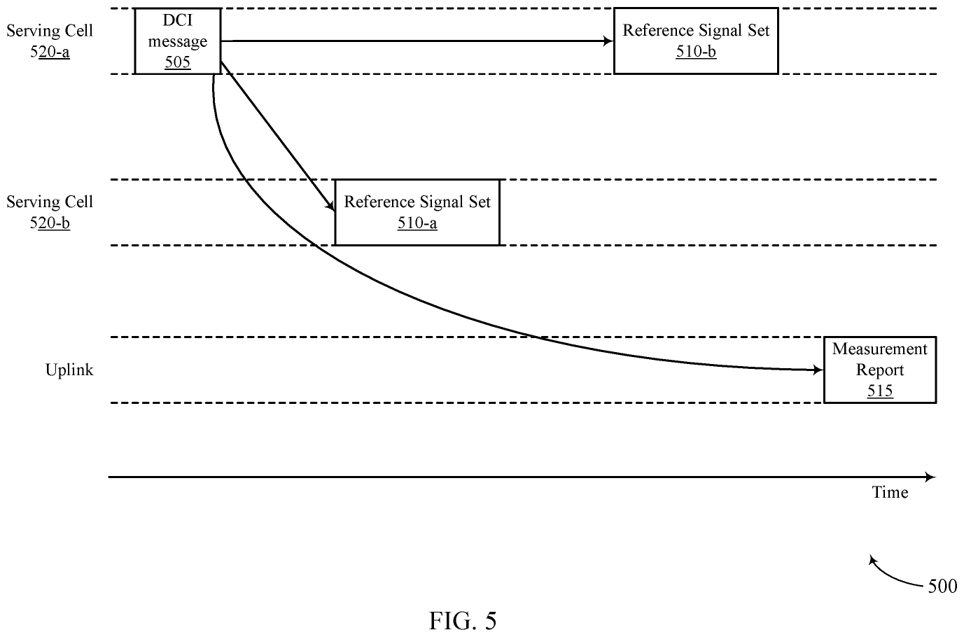

FIG. 5 shows an example of a signaling diagram 500 that supports measurement procedures for training of predictive beam management models in accordance with one or more aspects of the present disclosure. The signaling diagram 500 may implement or may be implemented by aspects of the wireless communications system 100 or the wireless communications system 200. For example, the signaling diagram 500 may include a DCI message 505, a reference signal set 510-a, a reference signal set 510-b, and a measurement report 515, which may be examples of signals communicated between a UE 115 and a network entity 105, which may be examples of corresponding devices as described herein with reference to FIGS. 1 and 2.

The network entity 105 may transmit a DCI message 505 via a PDCCH. The DCI message 505 may indicate (e.g., request) the UE 115 to measure reference signals of multiple reference signal sets 510 and transmit a measurement report 515 (e.g., aperiodic L1-RSRP reporting) including measurements associated with the reference signal set 510-a and the reference signal set 510-b. The DCI message 505 may indicate a first set of resources corresponding to the reference signal set 510-a and a second set of resources corresponding to the reference signal set 510-b. The UE 115 may receive the reference signal set 510-a via the first set of resources and may receive the reference signal set 510-b via the second set of resources. In some examples, the network entity 105 may use data (e.g., measurements) the network entity 105 receives via the measurement report 515 for beam management data collection.

The reference signal set 510-a may be associated with a serving cell 520-b and may include CSI-RSs or SSBs. The reference signal set 510-b may be associated with a serving cell 520-a and may include CSI-RSs or SSBs. In some cases, the reference signal set 510-a may include relatively wider beams (e.g., SSBs) compared with the reference signal set 510-b, which may include relatively narrower beams (e.g., CSI-RSs), or vice versa. Alternatively, the reference signal set 510-a and the reference signal set 510-b may both include relatively wide beams (e.g., SSBs) or may both include relatively narrow beams (e.g., CSI-RSs). Thus, the reference signal set 510-a and the reference signal set 510-b may support inter-cell wide beam to wide beam prediction, inter-cell wide beam to narrow beam prediction, inter-cell narrow beam to narrow beam prediction, or a combination thereof. The network entity 105 may transmit the reference signal set 510-a via the serving cell 520-a and may transmit the reference signal set 510-b via the serving cell 520-b. The network entity 105 may transmit an indication (e.g., a CSI report configuration) to the UE 115 that the reference signal set 510-a is associated with the serving cell 520-b and that the reference signal set 510-b is associated with the serving cell 520-a.

In some cases, the DCI message 505 may be a triggering DCI and may indicate (e.g., trigger) a CSI report configuration (e.g., a CSI report setting). The CSI report configuration may include a first parameter (e.g., resourceForChannelMeasurement) that indicates the first set of resources corresponding to the reference signal set 510-a and may include a second parameter (e.g., resourceForChannelMeasurment2) that indicates the second set of resources corresponding to the reference signal set 510-b. Accordingly, the network entity 105 may indicate the reference signal set 510-a and the reference signal set 510-b via a same CSI report configuration. In some examples, the CSI report configuration may include a third parameter (e.g., carrier) that indicates that the first set of resources corresponds to the serving cell 520-b (e.g., a first serving cell) and a fourth parameter (e.g., carrier2) that indicates that the second set of resources corresponds to the serving cell 520-a (e.g., a second serving cell).

The UE 115 may use a first receive beam for receiving the DCI message 505 via the serving cell 520-a, and the network entity 105 may configure the UE 115 with a second receive beam, different from the first receive beam, for measurement of the reference signal set 510-a, or a subset of the reference signal set 510-a, via the serving cell 520-b. In such cases, the network entity 105 may configure a first time duration (e.g., measurement gap, time gap) between transmission of the DCI message 505 and transmission of the reference signal set 510-a. The UE 115 may switch, during the first time duration, from the first receive beam to the second receive beam. The first time duration may be based on a UE capability. For example, the UE 115 may transmit an indication to the network entity 105 of a minimum time duration associated with a beam switching capability of the UE, and the first time duration may satisfy (e.g., be greater than or equal to) the minimum time duration. The indication of the minimum time duration may indicate a quantity of OFDM symbols.

The UE 115 may use the second receive beam for receiving the reference signal set 510-a, and the network entity 105 may configure the UE 115 with a third receive beam, different form the second receive beam, for measurement of the reference signal set 510-b via the serving cell 520-a. In such cases, the network entity 105 may configure a second time duration (e.g., measurement gap, time gap) between transmission of the reference signal set 510-a and the reference signal set 510-b (e.g., based on UE capability), and the UE 115 may switch, during the second time duration, from the second receive beam to the third receive beam. The 115 may use the third receive beam for receiving the reference signal set 510-b.

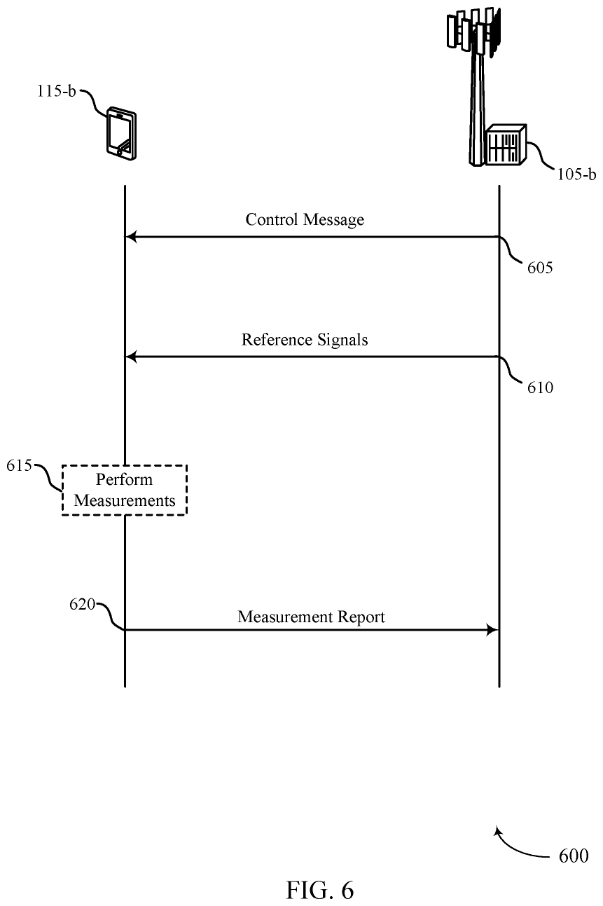

FIG. 6 shows an example of a process flow 600 that supports measurement procedures for training of predictive beam management models in accordance with one or more aspects of the present disclosure. The process flow 600 may implement or may be implemented by aspects of the wireless communications system 100 or the wireless communications system 200. For example, the process flow 600 may include a UE 115-b and a network entity 105-b, which may be examples of corresponding devices as described herein with reference to FIGS. 1 and 2. In the following description of the process flow 600, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 600, and other operations may be added to the process flow 600.

At 605, the UE 115-b may receive a control message that indicates, from multiple sets of resources associated with channel measurement (e.g., CMRs), a first set of resources and a second set of resources. The first set of resources may correspond to a first set of reference signals (e.g., a set A of reference signals, a set of reference signals corresponding to a set A of beams, SSBs, CSI-RSs, wide beams, or narrow beams) and the second set of resources may correspond to a second set of reference signals (e.g., a set B of reference signals, a set of reference signals corresponding to a set B of beams, SSBs, CSI-RSs, wide beams, or narrow beams). In some examples, the UE 115-b may receive a DCI message (e.g., triggering DCI) that includes an indication of a CSI report setting (e.g., CSI report configuration). The CSI report setting may include a first parameter (e.g., resourceForChannelMeasurement) that indicates the first set of resources and a second parameter (resourceForChannelMeasurement2) that indicates the second set of resources. Additionally, or alternatively, the CSI report setting may include one or more parameters (e.g., carrier, or both carrier and carrier2) that indicate one or more serving cells (e.g., a same serving cell or different serving cells) associated with the first set of resources and the second set of resources.

At 610, the UE 115-b may receive one or more first reference signals of the first set of reference signals via the first set of resources and one or more second reference signals of the second set of reference signals via the second set of resources. The UE 115-b may receive the one or more first reference signals and the one or more second reference signals via the same serving cell, or the UE 115-b may receive the one or more first reference signals via a first serving cell and may receive the one or more second reference signals via a second serving cell. In some examples, the UE 115-b may receive an indication of the one or more first reference signals, which may be a subset (e.g., SSB subset) of the first set of reference signals (e.g., SSB burst), or the one or more second reference signals, which may be a subset (e.g., SSB subset) of the second set of reference signals (e.g., SSB burst).

At 615, the UE 115-b may measure the one or more first reference signals and the one or more second reference signals. In some examples, the UE 115-b may receive an indication of a single receive beam (e.g., common UE receive beam) associated with measurement of each reference signal of the one or more first reference signals and the one or more second reference signals, and the UE 115-b may measure the one or more first reference signal and the one or more second reference signals using the single receive beam. In other examples, the UE 115-b may receive an indication of a first receive beam (e.g., separate UE receive beam) associated with measurement of each reference signal of the one or more first reference signals and a second receive beam (e.g., separate UE receive beam) associated with measurement of each reference signal of the one or more second reference signals. In such examples, the UE 115-b may measure the one or more first reference signals using the first receive beam and may measure the one or more second reference signals using the second receive beam.

At 620, the UE 115-b may transmit a measurement repot including at least a first measurement associated with at least one of the one or more first reference signals and at least a second measurement associated with at last one of the one or more second reference signals. The UE 115-b may transmit the measurement report based on the control message and reception of the one or more first reference signals and the one or more second reference signals. In some examples, the UE 115-b may receive a request for measurement reporting of each of the first set of reference signals and each of the second set of reference signals (e.g., any configured reference signal). In such examples, the measurement report may include a set of measurements that correspond to the first set of reference signals and the second set of reference signals. In other examples, the UE 115-b may receive a request for measurement reporting of a first subset (e.g., top-K reference signals) of the first set of reference signals and a second subset (e.g., top-K reference signals) of the second set of reference signals. In such examples, the measurement report may include a first set of measurements that correspond to the first subset of the first set of reference signals and a second set of measurements that correspond to the second subset of the second set of reference signals.

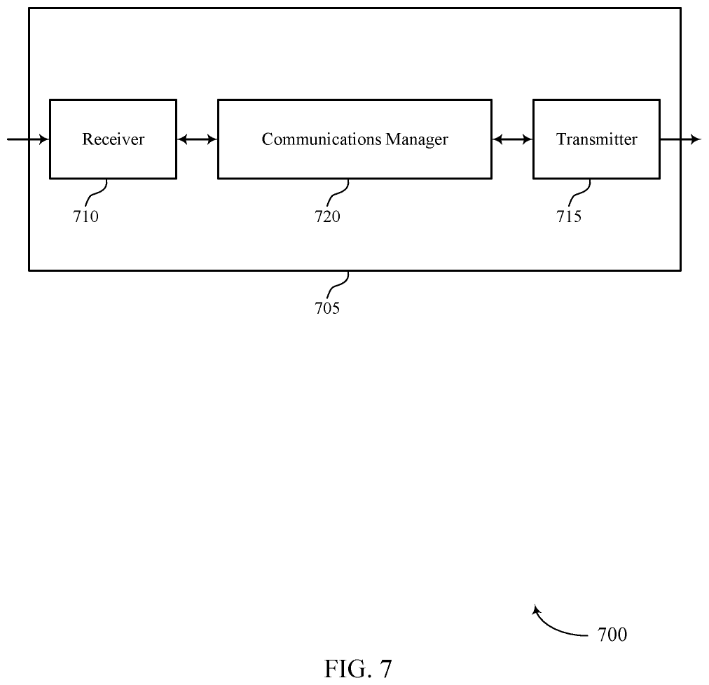

FIG. 7 shows a block diagram 700 of a device 705 that supports measurement procedures for training of predictive beam management models in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to measurement procedures for training of predictive beam management models). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to measurement procedures for training of predictive beam management models). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of measurement procedures for training of predictive beam management models as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a control message that indicates, from a set of multiple sets of resources associated with channel measurement, a first set of resources and a second set of resources, where the first set of resources corresponds to a first set of reference signals and the second set of resources corresponds to a second set of reference signals. The communications manager 720 is capable of, configured to, or operable to support a means for receiving one or more first reference signals of the first set of reference signals via the first set of resources and one or more second reference signals of the second set of reference signals via the second set of resources. The communications manager 720 is capable of, configured to, or operable to support a means for transmitting a measurement report including at least a first measurement associated with at least one of the one or more first reference signals and at least a second measurement associated with at least one of the one or more second reference signals based on the control message and reception of the one or more first reference signals and the one or more second reference signals.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing and reduced power consumption. For example, the processor of the device 705 may measure set A reference signals and set B reference signals for transmitting via a single measurement report, which may reduce power consumption and processing by reducing a quantity of signals transmitted by the UE.

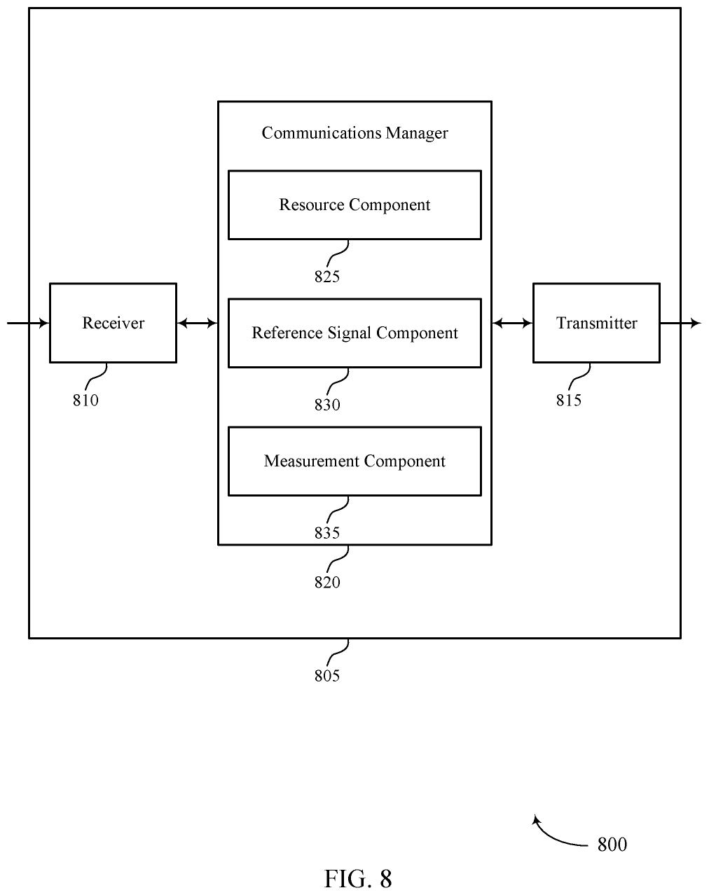

FIG. 8 shows a block diagram 800 of a device 805 that supports measurement procedures for training of predictive beam management models in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to measurement procedures for training of predictive beam management models). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to measurement procedures for training of predictive beam management models). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of measurement procedures for training of predictive beam management models as described herein. For example, the communications manager 820 may include a resource component 825, a reference signal component 830, a measurement component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The resource component 825 is capable of, configured to, or operable to support a means for receiving a control message that indicates, from a set of multiple sets of resources associated with channel measurement, a first set of resources and a second set of resources, where the first set of resources corresponds to a first set of reference signals and the second set of resources corresponds to a second set of reference signals. The reference signal component 830 is capable of, configured to, or operable to support a means for receiving one or more first reference signals of the first set of reference signals via the first set of resources and one or more second reference signals of the second set of reference signals via the second set of resources. The measurement component 835 is capable of, configured to, or operable to support a means for transmitting a measurement report including at least a first measurement associated with at least one of the one or more first reference signals and at least a second measurement associated with at least one of the one or more second reference signals based on the control message and reception of the one or more first reference signals and the one or more second reference signals.

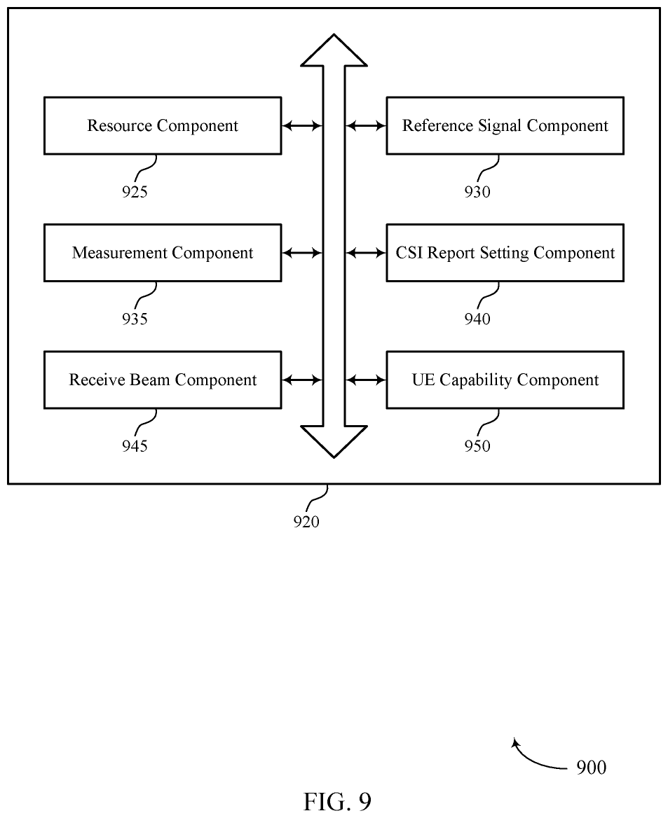

FIG. 9 shows a block diagram 900 of a communications manager 920 that supports measurement procedures for training of predictive beam management models in accordance with one or more aspects of the present disclosure. The communications manager 920 may be an example of aspects of a communications manager 720, a communications manager 820, or both, as described herein. The communications manager 920, or various components thereof, may be an example of means for performing various aspects of measurement procedures for training of predictive beam management models as described herein. For example, the communications manager 920 may include a resource component 925, a reference signal component 930, a measurement component 935, a CSI report setting component 940, a receive beam component 945, a UE capability component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The resource component 925 is capable of, configured to, or operable to support a means for receiving a control message that indicates, from a set of multiple sets of resources associated with channel measurement, a first set of resources and a second set of resources, where the first set of resources corresponds to a first set of reference signals and the second set of resources corresponds to a second set of reference signals. The reference signal component 930 is capable of, configured to, or operable to support a means for receiving one or more first reference signals of the first set of reference signals via the first set of resources and one or more second reference signals of the second set of reference signals via the second set of resources. The measurement component 935 is capable of, configured to, or operable to support a means for transmitting a measurement report including at least a first measurement associated with at least one of the one or more first reference signals and at least a second measurement associated with at least one of the one or more second reference signals based on the control message and reception of the one or more first reference signals and the one or more second reference signals.

In some examples, to support receiving the control message, the CSI report setting component 940 is capable of, configured to, or operable to support a means for receiving a DCI message that includes an indication of a CSI report setting, the CSI report setting including a first parameter that indicates the first set of resources and a second parameter that indicates the second set of resources.

In some examples, to support receiving the control message, the CSI report setting component 940 is capable of, configured to, or operable to support a means for receiving a DCI message that includes an indication of a CSI report setting, the CSI report setting including one or more parameters that indicate one or more serving cells associated with the first set of resources and the second set of resources.

In some examples, the one or more parameters include a single parameter that indicates that the first set of resources and the second set of resources correspond to a same serving cell, and to support receiving the one or more first reference signals and the one or more second reference signals, the reference signal component 930 is capable of, configured to, or operable to support a means for receiving the one or more first reference signals and the one or more second reference signals via the same serving cell.

In some examples, the one or more parameters include a first parameter that indicates that the first set of resources corresponds to a first serving cell and a second parameter that indicates that the second set of resources corresponds to a second serving cell. In some examples, to support receiving the one or more first reference signals and the one or more second reference signals, the reference signal component 930 is capable of, configured to, or operable to support a means for receiving the one or more first reference signals via a first serving cell. In some examples, to support receiving the one or more first reference signals and the one or more second reference signals, the reference signal component 930 is capable of, configured to, or operable to support a means for receiving the one or more second reference signals via a second serving cell.

In some examples, the reference signal component 930 is capable of, configured to, or operable to support a means for receiving an indication of the one or more first reference signals or the one or more second reference signals, the one or more first reference signals or the one or more second reference signals being a subset of the first set of reference signals or the second set of reference signals, respectively.

In some examples, the receive beam component 945 is capable of, configured to, or operable to support a means for receiving an indication of a single receive beam associated with measurement of each reference signal of the one or more first reference signals and each reference signal of the one or more second reference signals. In some examples, the measurement component 935 is capable of, configured to, or operable to support a means for measuring the one or more first reference signals and the one or more second reference signals using the single receive beam, where at least the first measurement and at least the second measurement are based on using the single receive beam.

In some examples, the receive beam component 945 is capable of, configured to, or operable to support a means for receiving an indication of a first receive beam associated with measurement of each reference signal of the one or more first reference signals and a second receive beam associated with measurement of each reference signal of the one or more second reference signals. In some examples, the measurement component 935 is capable of, configured to, or operable to support a means for measuring the one or more first reference signals using the first receive beam to generate the first measurement. In some examples, the measurement component 935 is capable of, configured to, or operable to support a means for measuring the one or more second reference signals using the second receive beam to generate the second measurement.

In some examples, the receive beam component 945 is capable of, configured to, or operable to support a means for switching, during a time duration between the first set of resources and the second set of resources, from the first receive beam to the second receive beam based on the first receive beam being associated with the measurement of each reference signal of the one or more first reference signals and the second receive beam being associated with the measurement of each reference signal of the one or more second reference signals.

In some examples, the UE capability component 950 is capable of, configured to, or operable to support a means for transmitting an indication of a minimum time duration associated with a beam switching capability of the UE, where the time duration between the first set of resources and the second set of resources is greater than or equal to the minimum time duration.

In some examples, the measurement component 935 is capable of, configured to, or operable to support a means for receiving a request for measurement reporting of each of the first set of reference signals and each of the second set of reference signals, where the measurement report includes a set of measurements that correspond to the first set of reference signals and the second set of reference signals.

In some examples, to support measurement report, the measurement component 935 is capable of, configured to, or operable to support a means for an absolute measurement that corresponds to a reference signal, of the first set of reference signals or the second set of reference signals, associated with a highest reference signal receive power (RSRP) measurement. In some examples, to support measurement report, the measurement component 935 is capable of, configured to, or operable to support a means for a resource index that corresponds to the reference signal associated with the highest RSRP measurement. In some examples, to support measurement report, the measurement component 935 is capable of, configured to, or operable to support a means for differential measurements, relative to the absolute measurement, for each of a remainder of the first set of reference signals and the second set of reference signals.

In some examples, the measurement component 935 is capable of, configured to, or operable to support a means for receiving a request for measurement reporting of a first subset of the first set of reference signals and a second subset of the second set of reference signals, where the measurement report includes a first set of measurements that correspond to the first subset of the first set of reference signals and a second set of measurements that correspond to the second subset of the second set of reference signals, and where the one or more first reference signals include the first subset and the one or more second reference signals include the second subset.

In some examples, to support measurement report, the measurement component 935 is capable of, configured to, or operable to support a means for first resource indices that correspond to the first subset of the first set of reference signals. In some examples, to support measurement report, the measurement component 935 is capable of, configured to, or operable to support a means for an absolute measurement that corresponds to a reference signal, of the first subset of the first set of reference signals, associated with a highest reference signal receive power (RSRP) measurement. In some examples, to support measurement report, the measurement component 935 is capable of, configured to, or operable to support a means for first differential measurements, relative to the absolute measurement, for each of a remainder of the first subset of the first set of reference signals. In some examples, to support measurement report, the measurement component 935 is capable of, configured to, or operable to support a means for second resource indices that correspond to the second subset of the second set of reference signals. In some examples, to support measurement report, the measurement component 935 is capable of, configured to, or operable to support a means for second differential measurements, relative to the absolute measurement, for each of the second subset of the second set of reference signals.

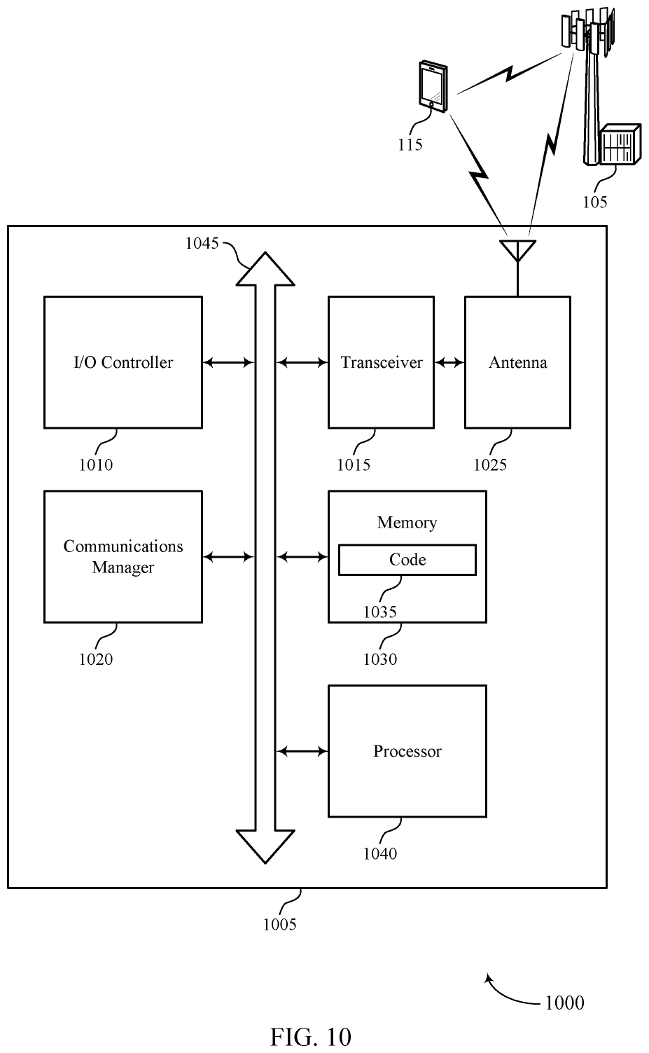

FIG. 10 shows a diagram of a system 1000 including a device 1005 that supports measurement procedures for training of predictive beam management models in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting measurement procedures for training of predictive beam management models). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a control message that indicates, from a set of multiple sets of resources associated with channel measurement, a first set of resources and a second set of resources, where the first set of resources corresponds to a first set of reference signals and the second set of resources corresponds to a second set of reference signals. The communications manager 1020 is capable of, configured to, or operable to support a means for receiving one or more first reference signals of the first set of reference signals via the first set of resources and one or more second reference signals of the second set of reference signals via the second set of resources. The communications manager 1020 is capable of, configured to, or operable to support a means for transmitting a measurement report including at least a first measurement associated with at least one of the one or more first reference signals and at least a second measurement associated with at least one of the one or more second reference signals based on the control message and reception of the one or more first reference signals and the one or more second reference signals.

By including or configuring the communications manager 1020 in accordance with examples as described herein, the device 1005 may support techniques for improved communication reliability and longer battery life. For example, the antenna 1025 may receive a beamformed communication via a downlink beam that is output by a trained AI/ML model, which may improve communication reliability and efficiency by increasing a received power at the UE for the beamformed communication. In some examples, the antenna 1025 may transmit a single measurement report including measurements for set A and set B reference signals, which may support reduced signaling and improved battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of measurement procedures for training of predictive beam management models as described herein, or the at least one processor 1040 and the at least one memory 1030 may be otherwise configured to, individually or collectively, perform or support such operations.

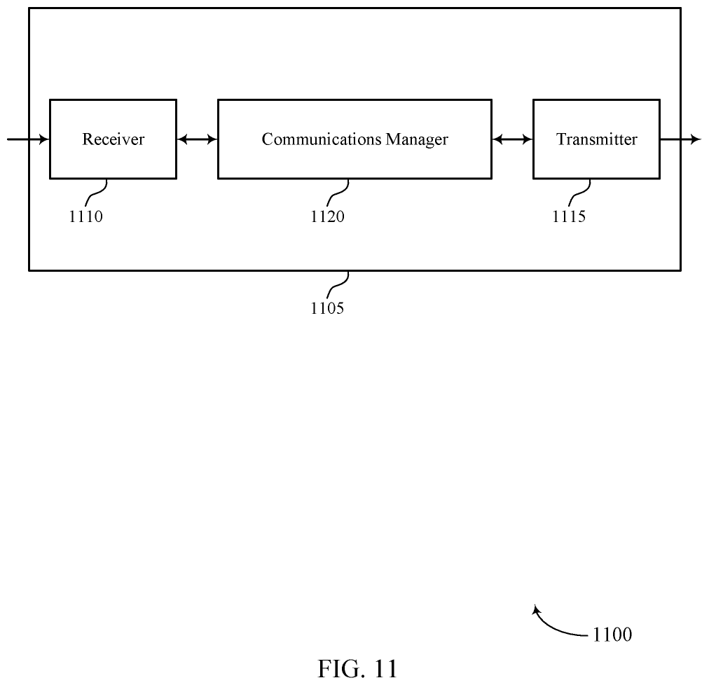

FIG. 11 shows a block diagram 1100 of a device 1105 that supports measurement procedures for training of predictive beam management models in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of measurement procedures for training of predictive beam management models as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting a control message that indicates, from a set of multiple sets of resources associated with channel measurement, a first set of resources and a second set of resources, where the first set of resources corresponds to a first set of reference signals and the second set of resources corresponds to a second set of reference signals. The communications manager 1120 is capable of, configured to, or operable to support a means for transmitting the first set of reference signals via the first set of resources and the second set of reference signals via the second set of resources. The communications manager 1120 is capable of, configured to, or operable to support a means for receiving a measurement report including at least a first measurement associated with at least one of the first set of reference signals and at least a second measurement associated with at least one of the second set of reference signals based on the control message and transmission of the first set of reference signals and the second set of reference signals.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing and reduced power consumption. For example, the processor of the device 1105 may transmit set A reference signals and set B reference signals and receive a report via a single measurement report, which may reduce power consumption and processing by reducing a quantity of signals received by the UE.

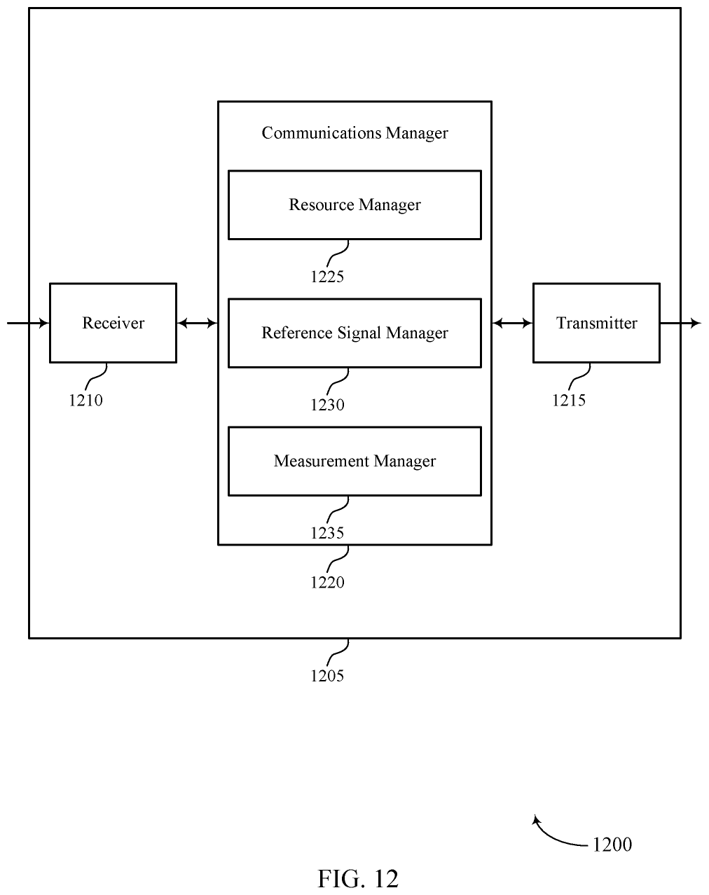

FIG. 12 shows a block diagram 1200 of a device 1205 that supports measurement procedures for training of predictive beam management models in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of measurement procedures for training of predictive beam management models as described herein. For example, the communications manager 1220 may include a resource manager 1225, a reference signal manager 1230, a measurement manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The resource manager 1225 is capable of, configured to, or operable to support a means for transmitting a control message that indicates, from a set of multiple sets of resources associated with channel measurement, a first set of resources and a second set of resources, where the first set of resources corresponds to a first set of reference signals and the second set of resources corresponds to a second set of reference signals. The reference signal manager 1230 is capable of, configured to, or operable to support a means for transmitting the first set of reference signals via the first set of resources and the second set of reference signals via the second set of resources. The measurement manager 1235 is capable of, configured to, or operable to support a means for receiving a measurement report including at least a first measurement associated with at least one of the first set of reference signals and at least a second measurement associated with at least one of the second set of reference signals based on the control message and transmission of the first set of reference signals and the second set of reference signals.

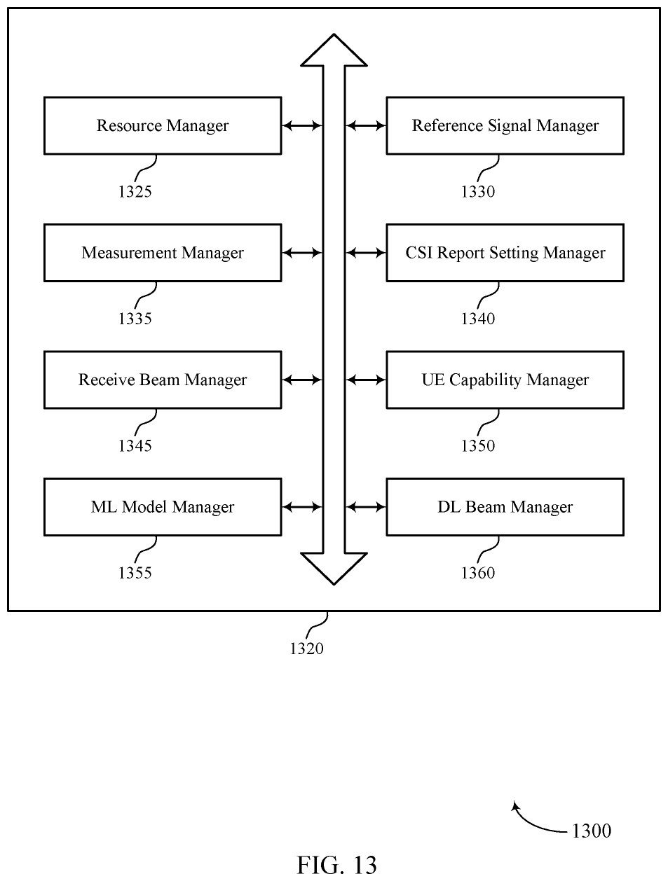

FIG. 13 shows a block diagram 1300 of a communications manager 1320 that supports measurement procedures for training of predictive beam management models in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of measurement procedures for training of predictive beam management models as described herein. For example, the communications manager 1320 may include a resource manager 1325, a reference signal manager 1330, a measurement manager 1335, a CSI report setting manager 1340, a receive beam manager 1345, a UE capability manager 1350, an ML model manager 1355, a DL beam manager 1360, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The resource manager 1325 is capable of, configured to, or operable to support a means for transmitting a control message that indicates, from a set of multiple sets of resources associated with channel measurement, a first set of resources and a second set of resources, where the first set of resources corresponds to a first set of reference signals and the second set of resources corresponds to a second set of reference signals. The reference signal manager 1330 is capable of, configured to, or operable to support a means for transmitting the first set of reference signals via the first set of resources and the second set of reference signals via the second set of resources. The measurement manager 1335 is capable of, configured to, or operable to support a means for receiving a measurement report including at least a first measurement associated with at least one of the first set of reference signals and at least a second measurement associated with at least one of the second set of reference signals based on the control message and transmission of the first set of reference signals and the second set of reference signals.

In some examples, to support transmitting the control message, the CSI report setting manager 1340 is capable of, configured to, or operable to support a means for transmitting a DCI message that includes an indication of a CSI report setting, the CSI report setting including a first parameter that indicates the first set of resources and a second parameter that indicates the second set of resources.

In some examples, to support transmitting the control message, the CSI report setting manager 1340 is capable of, configured to, or operable to support a means for transmitting a DCI message that includes an indication of a CSI report setting, the CSI report setting including one or more parameters that indicate one or more serving cells associated with the first set of resources and the second set of resources.

In some examples, the one or more parameters include a single parameter that indicates that the first set of resources and the second set of resources correspond to a same serving cell and, to support transmitting the first set of reference signals and the second set of reference signals, the reference signal manager 1330 is capable of, configured to, or operable to support a means for transmitting the first set of reference signals and the second set of reference signals via the same serving cell.

In some examples, the one or more parameters include a first parameter that indicates that the first set of resources corresponds to a first serving cell and a second parameter that indicates that the second set of resources corresponds to a second serving cell. In some examples, to support transmitting the first set of reference signals and the second set of reference signals, the reference signal manager 1330 is capable of, configured to, or operable to support a means for transmitting the first set of reference signals via a first serving cell. In some examples, to support transmitting the first set of reference signals and the second set of reference signals, the reference signal manager 1330 is capable of, configured to, or operable to support a means for transmitting the second set of reference signals via a second serving cell.

In some examples, the reference signal manager 1330 is capable of, configured to, or operable to support a means for transmitting an indication of one or more first reference signals of the first set of reference signals or one or more second reference signals of the second set of reference signals, the one or more first reference signals or the one or more second reference signals being a subset of the first set of reference signals or the second set of reference signals, respectively. In some examples, the measurement manager 1335 is capable of, configured to, or operable to support a means for receiving, via the measurement report, a set of measurements associated with one or both of the one or more first reference signals or the one or more second reference signals.

In some examples, the receive beam manager 1345 is capable of, configured to, or operable to support a means for transmitting an indication of a single receive beam associated with measurement of each reference signal of the first set of reference signals and each reference signal of the second set of reference signals.

In some examples, the receive beam manager 1345 is capable of, configured to, or operable to support a means for transmitting an indication of a first receive beam associated with measurement of the first set of reference signals and a second receive beam associated with measurement of the second set of reference signals.

In some examples, the UE capability manager 1350 is capable of, configured to, or operable to support a means for receiving an indication of a minimum time duration associated with a beam switching capability of a UE, where a time duration between the first set of resources and the second set of resources is greater than or equal to the minimum time duration.

In some examples, the measurement manager 1335 is capable of, configured to, or operable to support a means for transmitting a request for measurement reporting of each of the first set of reference signals and each of the second set of reference signals, where the measurement report includes a set of measurements that correspond to the first set of reference signals and the second set of reference signals.

In some examples, to support measurement report, the measurement manager 1335 is capable of, configured to, or operable to support a means for an absolute measurement that corresponds to a reference signal, of the first set of reference signals or the second set of reference signals, associated with a highest reference signal receive power (RSRP) measurement. In some examples, to support measurement report, the measurement manager 1335 is capable of, configured to, or operable to support a means for a resource index that corresponds to the reference signal associated with the highest RSRP measurement. In some examples, to support measurement report, the measurement manager 1335 is capable of, configured to, or operable to support a means for differential measurements, relative to the absolute measurement, for each of a remainder of the first set of reference signals and the second set of reference signals.

In some examples, the measurement manager 1335 is capable of, configured to, or operable to support a means for transmitting a request for measurement reporting of a first subset of the first set of reference signals and a second subset of the second set of reference signals, where the measurement report includes a first set of measurements that correspond to the first subset of the first set of reference signals and a second set of measurements that correspond to the second subset of the second set of reference signals.

In some examples, to support measurement report, the measurement manager 1335 is capable of, configured to, or operable to support a means for first resource indices that correspond to the first subset of the first set of reference signals. In some examples, to support measurement report, the measurement manager 1335 is capable of, configured to, or operable to support a means for an absolute measurement that corresponds to a reference signal, of the first subset of the first set of reference signals, associated with a highest reference signal receive power (RSRP) measurement. In some examples, to support measurement report, the measurement manager 1335 is capable of, configured to, or operable to support a means for first differential measurements, relative to the absolute measurement, for each of a remainder of the first subset of the first set of reference signals. In some examples, to support measurement report, the measurement manager 1335 is capable of, configured to, or operable to support a means for second resource indices that correspond to the second subset of the second set of reference signals. In some examples, to support measurement report, the measurement manager 1335 is capable of, configured to, or operable to support a means for second differential measurements, relative to the absolute measurement, for each of the second subset of the second set of reference signals.

In some examples, the ML model manager 1355 is capable of, configured to, or operable to support a means for training a ML model configured to predict spatial-domain characteristics associated with the second set of reference signals based on at least the first measurement and at least the second measurement. In some examples, the DL beam manager 1360 is capable of, configured to, or operable to support a means for selecting a downlink beam for communication with a UE based on an output of the ML model.

In some examples, the measurement manager 1335 is capable of, configured to, or operable to support a means for receiving measurement information associated with at least a subset of the first set of reference signals. In some examples, the ML model manager 1355 is capable of, configured to, or operable to support a means for inputting the measurement information into the ML model. In some examples, the DL beam manager 1360 is capable of, configured to, or operable to support a means for obtaining, as an output of the ML model, predicted spatial-domain characteristics associated with the second set of reference signals, where selecting the downlink beam is based on the predicted spatial-domain characteristics.

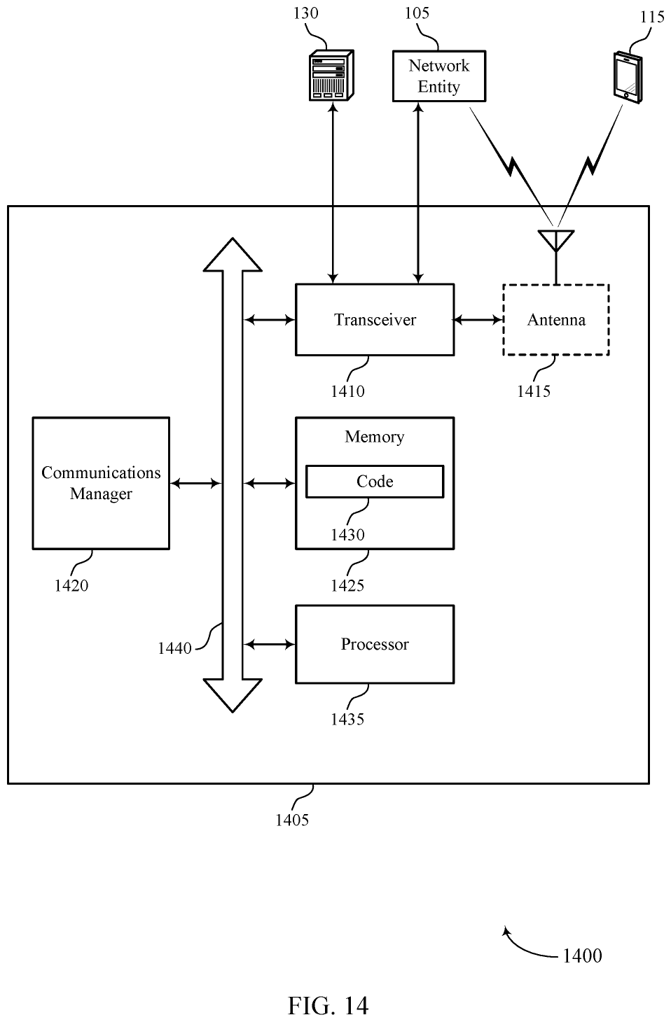

FIG. 14 shows a diagram of a system 1400 including a device 1405 that supports measurement procedures for training of predictive beam management models in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting measurement procedures for training of predictive beam management models). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. In some implementations, a processing system may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting a control message that indicates, from a set of multiple sets of resources associated with channel measurement, a first set of resources and a second set of resources, where the first set of resources corresponds to a first set of reference signals and the second set of resources corresponds to a second set of reference signals. The communications manager 1420 is capable of, configured to, or operable to support a means for transmitting the first set of reference signals via the first set of resources and the second set of reference signals via the second set of resources. The communications manager 1420 is capable of, configured to, or operable to support a means for receiving a measurement report including at least a first measurement associated with at least one of the first set of reference signals and at least a second measurement associated with at least one of the second set of reference signals based on the control message and transmission of the first set of reference signals and the second set of reference signals.

By including or configuring the communications manager 1420 in accordance with examples as described herein, the device 1405 may support techniques for improved communication reliability and longer battery life. For example, the antenna 1415 may transmit a beamformed communication via a downlink beam that is output by a trained AI/ML model, which may improve communication reliability and efficiency by increasing a received power at the UE for the beamformed communication. In some examples, the antenna 1415 may receive a single measurement report including measurements for set A and set B reference signals, which may support reduced signaling and improved battery life.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of measurement procedures for training of predictive beam management models as described herein, or the at least one processor 1435 and the at least one memory 1425 may be otherwise configured to, individually or collectively, perform or support such operations.

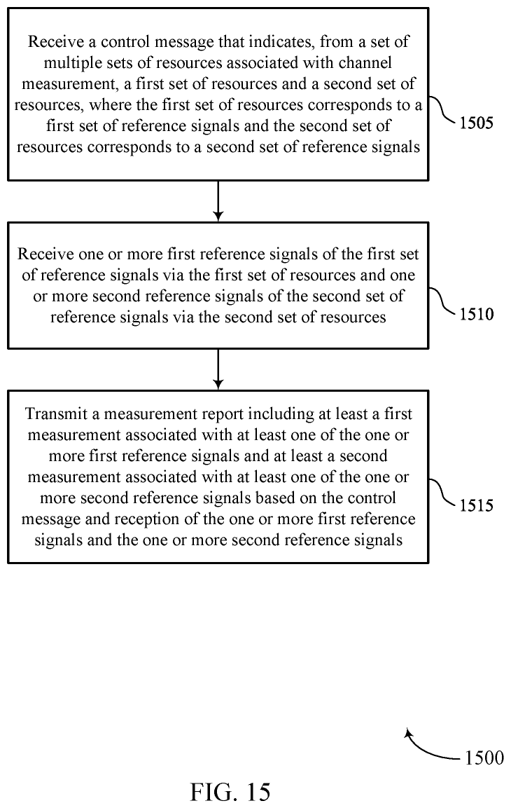

FIG. 15 shows a flowchart illustrating a method 1500 that supports measurement procedures for training of predictive beam management models in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control message that indicates, from a set of multiple sets of resources associated with channel measurement, a first set of resources and a second set of resources, where the first set of resources corresponds to a first set of reference signals and the second set of resources corresponds to a second set of reference signals. The operations of block 1505 may be performed in accordance with examples as disclosed herein. In some examples, aspects of the operations of 1505 may be performed by a resource component 925 as described with reference to FIG. 9.

At 1510, the method may include receiving one or more first reference signals of the first set of reference signals via the first set of resources and one or more second reference signals of the second set of reference signals via the second set of resources. The operations of block 1510 may be performed in accordance with examples as disclosed herein. In some examples, aspects of the operations of 1510 may be performed by a reference signal component 930 as described with reference to FIG. 9.

At 1515, the method may include transmitting a measurement report including at least a first measurement associated with at least one of the one or more first reference signals and at least a second measurement associated with at least one of the one or more second reference signals based on the control message and reception of the one or more first reference signals and the one or more second reference signals. The operations of block 1515 may be performed in accordance with examples as disclosed herein. In some examples, aspects of the operations of 1515 may be performed by a measurement component 935 as described with reference to FIG. 9.

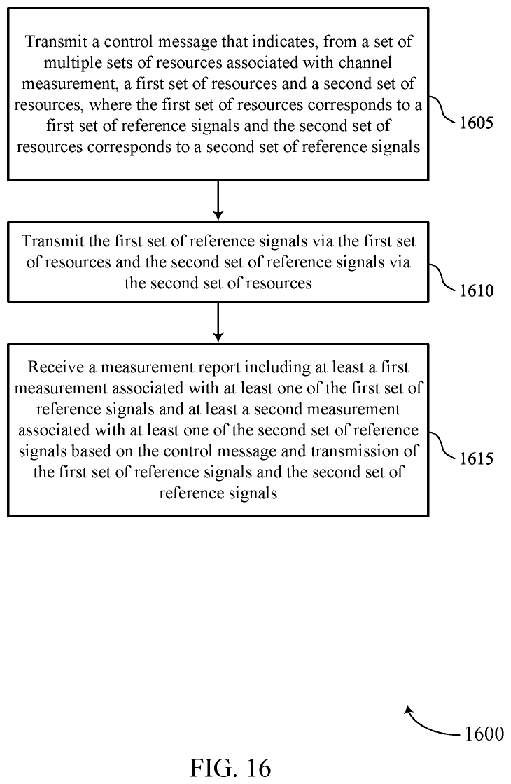

FIG. 16 shows a flowchart illustrating a method 1600 that supports measurement procedures for training of predictive beam management models in accordance with aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message that indicates, from a set of multiple sets of resources associated with channel measurement, a first set of resources and a second set of resources, where the first set of resources corresponds to a first set of reference signals and the second set of resources corresponds to a second set of reference signals. The operations of block 1605 may be performed in accordance with examples as disclosed herein. In some examples, aspects of the operations of 1605 may be performed by a resource manager 1325 as described with reference to FIG. 13.

At 1610, the method may include transmitting the first set of reference signals via the first set of resources and the second set of reference signals via the second set of resources. The operations of block 1610 may be performed in accordance with examples as disclosed herein. In some examples, aspects of the operations of 1610 may be performed by a reference signal manager 1330 as described with reference to FIG. 13.

At 1615, the method may include receiving a measurement report including at least a first measurement associated with at least one of the first set of reference signals and at least a second measurement associated with at least one of the second set of reference signals based on the control message and transmission of the first set of reference signals and the second set of reference signals. The operations of block 1615 may be performed in accordance with examples as disclosed herein. In some examples, aspects of the operations of 1615 may be performed by a measurement manager 1335 as described with reference to FIG. 13.

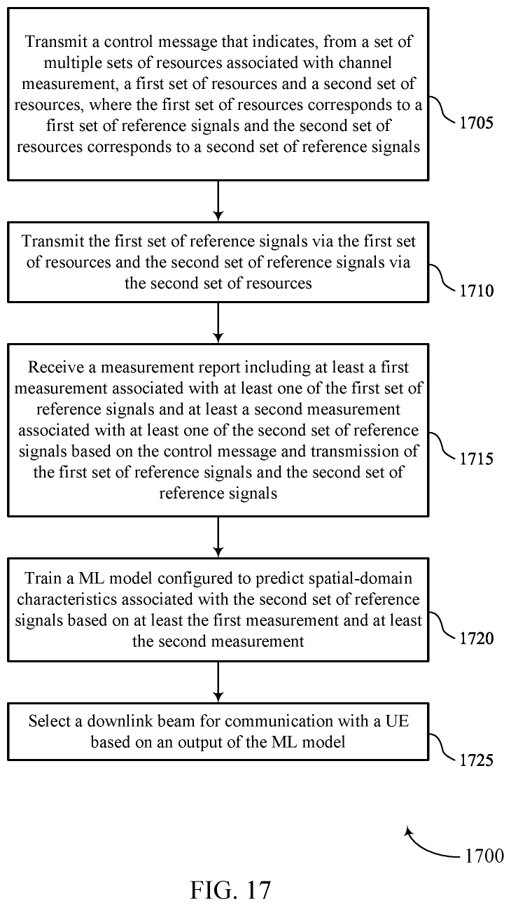

FIG. 17 shows a flowchart illustrating a method 1700 that supports measurement procedures for training of predictive beam management models in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control message that indicates, from a set of multiple sets of resources associated with channel measurement, a first set of resources and a second set of resources, where the first set of resources corresponds to a first set of reference signals and the second set of resources corresponds to a second set of reference signals. The operations of block 1705 may be performed in accordance with examples as disclosed herein. In some examples, aspects of the operations of 1705 may be performed by a resource manager 1325 as described with reference to FIG. 13.

At 1710, the method may include transmitting the first set of reference signals via the first set of resources and the second set of reference signals via the second set of resources. The operations of block 1710 may be performed in accordance with examples as disclosed herein. In some examples, aspects of the operations of 1710 may be performed by a reference signal manager 1330 as described with reference to FIG. 13.

At 1715, the method may include receiving a measurement report including at least a first measurement associated with at least one of the first set of reference signals and at least a second measurement associated with at least one of the second set of reference signals based on the control message and transmission of the first set of reference signals and the second set of reference signals. The operations of block 1715 may be performed in accordance with examples as disclosed herein. In some examples, aspects of the operations of 1715 may be performed by a measurement manager 1335 as described with reference to FIG. 13.

At 1720, the method may include training a ML model configured to predict spatial-domain characteristics associated with the second set of reference signals based on at least the first measurement and at least the second measurement. The operations of block 1720 may be performed in accordance with examples as disclosed herein. In some examples, aspects of the operations of 1720 may be performed by an ML model manager 1355 as described with reference to FIG. 13.

At 1725, the method may include selecting a downlink beam for communication with a UE based on an output of the ML model. The operations of block 1725 may be performed in accordance with examples as disclosed herein. In some examples, aspects of the operations of 1725 may be performed by a DL beam manager 1360 as described with reference to FIG. 13.

The following provides an overview of aspects of the present disclosure:

Aspect 1: A method for wireless communications by a UE, comprising: receiving a control message that indicates, from a plurality of sets of resources associated with channel measurement, a first set of resources and a second set of resources, wherein the first set of resources corresponds to a first set of reference signals and the second set of resources corresponds to a second set of reference signals; receiving one or more first reference signals of the first set of reference signals via the first set of resources and one or more second reference signals of the second set of reference signals via the second set of resources; and transmitting a measurement report comprising at least a first measurement associated with at least one of the one or more first reference signals and at least a second measurement associated with at least one of the one or more second reference signals based at least in part on the control message and reception of the one or more first reference signals and the one or more second reference signals.

Aspect 2: The method of aspect 1, wherein receiving the control message comprises: receiving a DCI message that includes an indication of a CSI report setting, the CSI report setting comprising a first parameter that indicates the first set of resources and a second parameter that indicates the second set of resources.

Aspect 3: The method of any of aspects 1 through 2, wherein receiving the control message comprises: receiving a DCI message that includes an indication of a CSI report setting, the CSI report setting comprising one or more parameters that indicate one or more serving cells associated with the first set of resources and the second set of resources.

Aspect 4: The method of aspect 3, wherein the one or more parameters comprise a single parameter that indicates that the first set of resources and the second set of resources correspond to a same serving cell, and wherein receiving the one or more first reference signals and the one or more second reference signals comprises: receiving the one or more first reference signals and the one or more second reference signals via the same serving cell.

Aspect 5: The method of any of aspects 3 through 4, wherein the one or more parameters comprise a first parameter that indicates that the first set of resources corresponds to a first serving cell and a second parameter that indicates that the second set of resources corresponds to a second serving cell, and wherein receiving the one or more first reference signals and the one or more second reference signals comprises: receiving the one or more first reference signals via a first serving cell; and receiving the one or more second reference signals via a second serving cell.

Aspect 6: The method of any of aspects 1 through 5, further comprising: receiving an indication of the one or more first reference signals or the one or more second reference signals, the one or more first reference signals or the one or more second reference signals being a subset of the first set of reference signals or the second set of reference signals, respectively.

Aspect 7: The method of any of aspects 1 through 6, further comprising: receiving an indication of a single receive beam associated with measurement of each reference signal of the one or more first reference signals and each reference signal of the one or more second reference signals; and measuring the one or more first reference signals and the one or more second reference signals using the single receive beam, wherein at least the first measurement and at least the second measurement are based at least in part on using the single receive beam.

Aspect 8: The method of any of aspects 1 through 7, further comprising: receiving an indication of a first receive beam associated with measurement of each reference signal of the one or more first reference signals and a second receive beam associated with measurement of each reference signal of the one or more second reference signals; measuring the one or more first reference signals using the first receive beam to generate the first measurement; and measuring the one or more second reference signals using the second receive beam to generate the second measurement.

Aspect 9: The method of aspect 8, further comprising: switching, during a time duration between the first set of resources and the second set of resources, from the first receive beam to the second receive beam based at least in part on the first receive beam being associated with the measurement of each reference signal of the one or more first reference signals and the second receive beam being associated with the measurement of each reference signal of the one or more second reference signals.

Aspect 10: The method of aspect 9, further comprising: transmitting an indication of a minimum time duration associated with a beam switching capability of the UE, wherein the time duration between the first set of resources and the second set of resources is greater than or equal to the minimum time duration.

Aspect 11: The method of any of aspects 1 through 10, further comprising: receiving a request for measurement reporting of each of the first set of reference signals and each of the second set of reference signals, wherein the measurement report comprises a set of measurements that correspond to the first set of reference signals and the second set of reference signals.

Aspect 12: The method of aspect 11, wherein the measurement report comprises: an absolute measurement that corresponds to a reference signal, of the first set of reference signals or the second set of reference signals, associated with a highest RSRP measurement; a resource index that corresponds to the reference signal associated with the highest RSRP measurement; and differential measurements, relative to the absolute measurement, for each of a remainder of the first set of reference signals and the second set of reference signals.

Aspect 13: The method of any of aspects 1 through 12, further comprising: receiving a request for measurement reporting of a first subset of the first set of reference signals and a second subset of the second set of reference signals, wherein the measurement report comprises a first set of measurements that correspond to the first subset of the first set of reference signals and a second set of measurements that correspond to the second subset of the second set of reference signals, and wherein the one or more first reference signals comprise the first subset and the one or more second reference signals comprise the second subset.

Aspect 14: The method of aspect 13, wherein the measurement report comprises: first resource indices that correspond to the first subset of the first set of reference signals; an absolute measurement that corresponds to a reference signal, of the first subset of the first set of reference signals, associated with a highest RSRP measurement; first differential measurements, relative to the absolute measurement, for each of a remainder of the first subset of the first set of reference signals; second resource indices that correspond to the second subset of the second set of reference signals; and second differential measurements, relative to the absolute measurement, for each of the second subset of the second set of reference signals.

Aspect 15: A method for wireless communications by a network entity, comprising: transmitting a control message that indicates, from a plurality of sets of resources associated with channel measurement, a first set of resources and a second set of resources, wherein the first set of resources corresponds to a first set of reference signals and the second set of resources corresponds to a second set of reference signals; transmitting the first set of reference signals via the first set of resources and the second set of reference signals via the second set of resources; and receiving a measurement report comprising at least a first measurement associated with at least one of the first set of reference signals and at least a second measurement associated with at least one of the second set of reference signals based at least in part on the control message and transmission of the first set of reference signals and the second set of reference signals.

Aspect 16: The method of aspect 15, wherein transmitting the control message comprises: transmitting a DCI message that includes an indication of a CSI report setting, the CSI report setting comprising a first parameter that indicates the first set of resources and a second parameter that indicates the second set of resources.

Aspect 17: The method of any of aspects 15 through 16, wherein transmitting the control message comprises: transmitting a DCI message that includes an indication of a CSI report setting, the CSI report setting comprising one or more parameters that indicate one or more serving cells associated with the first set of resources and the second set of resources.

Aspect 18: The method of aspect 17, wherein the one or more parameters comprise a single parameter that indicates that the first set of resources and the second set of resources correspond to a same serving cell, and wherein transmitting the first set of reference signals and the second set of reference signals comprises: transmitting the first set of reference signals and the second set of reference signals via the same serving cell.

Aspect 19: The method of any of aspects 17 through 18, wherein the one or more parameters comprise a first parameter that indicates that the first set of resources corresponds to a first serving cell and a second parameter that indicates that the second set of resources corresponds to a second serving cell, and wherein transmitting the first set of reference signals and the second set of reference signals comprises: transmitting the first set of reference signals via a first serving cell; and transmitting the second set of reference signals via a second serving cell.

Aspect 20: The method of any of aspects 15 through 19, further comprising: transmitting an indication of one or more first reference signals of the first set of reference signals or one or more second reference signals of the second set of reference signals, the one or more first reference signals or the one or more second reference signals being a subset of the first set of reference signals or the second set of reference signals, respectively; and receiving, via the measurement report, a set of measurements associated with one or both of the one or more first reference signals or the one or more second reference signals.

Aspect 21: The method of any of aspects 15 through 20, further comprising: transmitting an indication of a single receive beam associated with measurement of each reference signal of the first set of reference signals and each reference signal of the second set of reference signals.

Aspect 22: The method of any of aspects 15 through 21, further comprising: transmitting an indication of a first receive beam associated with measurement of the first set of reference signals and a second receive beam associated with measurement of the second set of reference signals.

Aspect 23: The method of any of aspects 15 through 22, further comprising: receiving an indication of a minimum time duration associated with a beam switching capability of a UE, wherein a time duration between the first set of resources and the second set of resources is greater than or equal to the minimum time duration.

Aspect 24: The method of any of aspects 15 through 23, further comprising: transmitting a request for measurement reporting of each of the first set of reference signals and each of the second set of reference signals, wherein the measurement report comprises a set of measurements that correspond to the first set of reference signals and the second set of reference signals.

Aspect 25: The method of aspect 24, wherein the measurement report comprises: an absolute measurement that corresponds to a reference signal, of the first set of reference signals or the second set of reference signals, associated with a highest RSRP measurement; a resource index that corresponds to the reference signal associated with the highest RSRP measurement; and differential measurements, relative to the absolute measurement, for each of a remainder of the first set of reference signals and the second set of reference signals.

Aspect 26: The method of any of aspects 15 through 25, further comprising: transmitting a request for measurement reporting of a first subset of the first set of reference signals and a second subset of the second set of reference signals, wherein the measurement report comprises a first set of measurements that correspond to the first subset of the first set of reference signals and a second set of measurements that correspond to the second subset of the second set of reference signals.

Aspect 27: The method of aspect 26, wherein the measurement report comprises: first resource indices that correspond to the first subset of the first set of reference signals; an absolute measurement that corresponds to a reference signal, of the first subset of the first set of reference signals, associated with a highest RSRP measurement; first differential measurements, relative to the absolute measurement, for each of a remainder of the first subset of the first set of reference signals; second resource indices that correspond to the second subset of the second set of reference signals; and second differential measurements, relative to the absolute measurement, for each of the second subset of the second set of reference signals.

Aspect 28: The method of any of aspects 15 through 27, further comprising: training a machine learning model configured to predict spatial-domain characteristics associated with the second set of reference signals based at least in part on at least the first measurement and at least the second measurement; and selecting a downlink beam for communication with a UE based at least in part on an output of the machine learning model.

Aspect 29: The method of aspect 28, further comprising: receiving measurement information associated with at least a subset of the first set of reference signals; inputting the measurement information into the machine learning model; and obtaining, as an output of the machine learning model, predicted spatial-domain characteristics associated with the second set of reference signals, wherein selecting the downlink beam is based at least in part on the predicted spatial-domain characteristics.

Aspect 30: A UE for wireless communications, comprising one or more memories storing processor-executable code, and one or more processors coupled with the one or more memories and individually or collectively operable to execute the code to cause the UE to perform a method of any of aspects 1 through 14.

Aspect 31: A UE for wireless communications, comprising at least one means for performing a method of any of aspects 1 through 14.

Aspect 32: A non-transitory computer-readable medium storing code for wireless communications, the code comprising instructions executable by one or more processors to perform a method of any of aspects 1 through 14.

Aspect 33: A network entity for wireless communications, comprising one or more memories storing processor-executable code, and one or more processors coupled with the one or more memories and individually or collectively operable to execute the code to cause the network entity to perform a method of any of aspects 15 through 29.

Aspect 34: A network entity for wireless communications, comprising at least one means for performing a method of any of aspects 15 through 29.

Aspect 35: A non-transitory computer-readable medium storing code for wireless communications, the code comprising instructions executable by one or more processors to perform a method of any of aspects 15 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that indicates, from a plurality of sets of resources associated with channel measurement, a first set of resources and a second set of resources, wherein the first set of resources corresponds to a first set of reference signals and the second set of resources corresponds to a second set of reference signals;
receive one or more first reference signals of the first set of reference signals via the first set of resources and one or more second reference signals of the second set of reference signals via the second set of resources; and
transmit a measurement report comprising at least a first measurement associated with at least one of the one or more first reference signals and at least a second measurement associated with at least one of the one or more second reference signals based at least in part on the control message and reception of the one or more first reference signals and the one or more second reference signals.

2. The UE of claim 1, wherein, to receive the control message, the one or more processors are individually or collectively operable to execute the code to cause the UE to:
receive a downlink control information message that includes an indication of a channel state information report setting, the channel state information report setting comprising a first parameter that indicates the first set of resources and a second parameter that indicates the second set of resources.

3. The UE of claim 1, wherein, to receive the control message, the one or more processors are individually or collectively operable to execute the code to cause the UE to:
receive a downlink control information message that includes an indication of a channel state information report setting, the channel state information report setting comprising one or more parameters that indicate one or more serving cells associated with the first set of resources and the second set of resources.

4. The UE of claim 3, wherein the one or more parameters comprise a single parameter that indicates that the first set of resources and the second set of resources correspond to a same serving cell, and wherein, to receive the one or more first reference signals and the one or more second reference signals, the one or more processors are individually or collectively operable to execute the code to cause the UE to:
receive the one or more first reference signals and the one or more second reference signals via the same serving cell.

5. The UE of claim 3, wherein the one or more parameters comprise a first parameter that indicates that the first set of resources corresponds to a first serving cell and a second parameter that indicates that the second set of resources corresponds to a second serving cell, and wherein, to receive the one or more first reference signals and the one or more second reference signals, the one or more processors are individually or collectively operable to execute the code to cause the UE to:
receive the one or more first reference signals via a first serving cell; and
receive the one or more second reference signals via a second serving cell.

6. The UE of claim 1, wherein the one or more processors are individually or collectively further operable to execute the code to cause the UE to:
receive an indication of the one or more first reference signals or the one or more second reference signals, the one or more first reference signals or the one or more second reference signals being a subset of the first set of reference signals or the second set of reference signals, respectively.

7. The UE of claim 1, wherein the one or more processors are individually or collectively further operable to execute the code to cause the UE to:
receive an indication of a single receive beam associated with measurement of each reference signal of the one or more first reference signals and each reference signal of the one or more second reference signals; and
measure the one or more first reference signals and the one or more second reference signals using the single receive beam, wherein at least the first measurement and at least the second measurement are based at least in part on using the single receive beam.

8. The UE of claim 1, wherein the one or more processors are individually or collectively further operable to execute the code to cause the UE to:
receive an indication of a first receive beam associated with measurement of each reference signal of the one or more first reference signals and a second receive beam associated with measurement of each reference signal of the one or more second reference signals;
measure the one or more first reference signals using the first receive beam to generate the first measurement; and
measure the one or more second reference signals using the second receive beam to generate the second measurement.

9. The UE of claim 8, wherein the one or more processors are individually or collectively further operable to execute the code to cause the UE to:
switching, during a time duration between the first set of resources and the second set of resources, from the first receive beam to the second receive beam based at least in part on the first receive beam being associated with the measurement of each reference signal of the one or more first reference signals and the second receive beam being associated with the measurement of each reference signal of the one or more second reference signals.

10. The UE of claim 9, wherein the one or more processors are individually or collectively further operable to execute the code to cause the UE to:
transmit an indication of a minimum time duration associated with a beam switching capability of the UE, wherein the time duration between the first set of resources and the second set of resources is greater than or equal to the minimum time duration.

11. The UE of claim 1, wherein the one or more processors are individually or collectively further operable to execute the code to cause the UE to:
receive a request for measurement reporting of each of the first set of reference signals and each of the second set of reference signals, wherein the measurement report comprises a set of measurements that correspond to the first set of reference signals and the second set of reference signals.

12. The UE of claim 11, wherein the measurement report comprises:
an absolute measurement that corresponds to a reference signal, of the first set of reference signals or the second set of reference signals, associated with a highest reference signal receive power (RSRP) measurement;
a resource index that corresponds to the reference signal associated with the highest RSRP measurement; and
differential measurements, relative to the absolute measurement, for each of a remainder of the first set of reference signals and the second set of reference signals.

13. The UE of claim 1, wherein the one or more processors are individually or collectively further operable to execute the code to cause the UE to:
receive a request for measurement reporting of a first subset of the first set of reference signals and a second subset of the second set of reference signals, wherein the measurement report comprises a first set of measurements that correspond to the first subset of the first set of reference signals and a second set of measurements that correspond to the second subset of the second set of reference signals, and wherein the one or more first reference signals comprise the first subset and the one or more second reference signals comprise the second subset.

14. The UE of claim 13, wherein the measurement report comprises:
first resource indices that correspond to the first subset of the first set of reference signals;
an absolute measurement that corresponds to a reference signal, of the first subset of the first set of reference signals, associated with a highest reference signal receive power (RSRP) measurement;
first differential measurements, relative to the absolute measurement, for each of a remainder of the first subset of the first set of reference signals;
second resource indices that correspond to the second subset of the second set of reference signals; and
second differential measurements, relative to the absolute measurement, for each of the second subset of the second set of reference signals.

15. A network entity, comprising:
one or more memories storing processor-executable code; and
one or more processors coupled with the one or more memories and individually or collectively operable to execute the code to cause the network entity to:
transmit a control message that indicates, from a plurality of sets of resources associated with channel measurement, a first set of resources and a second set of resources, wherein the first set of resources corresponds to a first set of reference signals and the second set of resources corresponds to a second set of reference signals;
transmit the first set of reference signals via the first set of resources and the second set of reference signals via the second set of resources; and
receive a measurement report comprising at least a first measurement associated with at least one of the first set of reference signals and at least a second measurement associated with at least one of the second set of reference signals based at least in part on the control message and transmission of the first set of reference signals and the second set of reference signals.

16. The network entity of claim 15, wherein, to transmit the control message, the one or more processors are individually or collectively operable to execute the code to cause the network entity to:
transmit a downlink control information message that includes an indication of a channel state information report setting, the channel state information report setting comprising a first parameter that indicates the first set of resources and a second parameter that indicates the second set of resources.

17. The network entity of claim 15, wherein, to transmit the control message, the one or more processors are individually or collectively operable to execute the code to cause the network entity to:
transmit a downlink control information message that includes an indication of a channel state information report setting, the channel state information report setting comprising one or more parameters that indicate one or more serving cells associated with the first set of resources and the second set of resources.

18. The network entity of claim 17, wherein the one or more parameters comprise a single parameter that indicates that the first set of resources and the second set of resources correspond to a same serving cell, and wherein, to transmit the first set of reference signals and the second set of reference signals, the one or more processors are individually or collectively operable to execute the code to cause the network entity to:
transmit the first set of reference signals and the second set of reference signals via the same serving cell.

19. The network entity of claim 17, wherein the one or more parameters comprise a first parameter that indicates that the first set of resources corresponds to a first serving cell and a second parameter that indicates that the second set of resources corresponds to a second serving cell, and wherein, to transmit the first set of reference signals and the second set of reference signals, the one or more processors are individually or collectively operable to execute the code to cause the network entity to:
transmit the first set of reference signals via a first serving cell; and
transmit the second set of reference signals via a second serving cell.

20. The network entity of claim 15, wherein the one or more processors are individually or collectively further operable to execute the code to cause the network entity to:
transmit an indication of one or more first reference signals of the first set of reference signals or one or more second reference signals of the second set of reference signals, the one or more first reference signals or the one or more second reference signals being a subset of the first set of reference signals or the second set of reference signals, respectively; and
receive, via the measurement report, a set of measurements associated with one or both of the one or more first reference signals or the one or more second reference signals.

21. The network entity of claim 15, wherein the one or more processors are individually or collectively further operable to execute the code to cause the network entity to:
transmit an indication of a single receive beam associated with measurement of each reference signal of the first set of reference signals and each reference signal of the second set of reference signals.

22. The network entity of claim 15, wherein the one or more processors are individually or collectively further operable to execute the code to cause the network entity to:
transmit an indication of a first receive beam associated with measurement of the first set of reference signals and a second receive beam associated with measurement of the second set of reference signals.

23. The network entity of claim 15, wherein the one or more processors are individually or collectively further operable to execute the code to cause the network entity to:
transmit a request for measurement reporting of each of the first set of reference signals and each of the second set of reference signals, wherein the measurement report comprises a set of measurements that correspond to the first set of reference signals and the second set of reference signals.

24. The network entity of claim 23, wherein the measurement report comprises:
an absolute measurement that corresponds to a reference signal, of the first set of reference signals or the second set of reference signals, associated with a highest reference signal receive power (RSRP) measurement;
a resource index that corresponds to the reference signal associated with the highest RSRP measurement; and
differential measurements, relative to the absolute measurement, for each of a remainder of the first set of reference signals and the second set of reference signals.

25. The network entity of claim 15, wherein the one or more processors are individually or collectively further operable to execute the code to cause the network entity to:
transmit a request for measurement reporting of a first subset of the first set of reference signals and a second subset of the second set of reference signals, wherein the measurement report comprises a first set of measurements that correspond to the first subset of the first set of reference signals and a second set of measurements that correspond to the second subset of the second set of reference signals.

26. The network entity of claim 25, wherein the measurement report comprises:
first resource indices that correspond to the first subset of the first set of reference signals;
an absolute measurement that corresponds to a reference signal, of the first subset of the first set of reference signals, associated with a highest reference signal receive power (RSRP) measurement;
first differential measurements, relative to the absolute measurement, for each of a remainder of the first subset of the first set of reference signals;
second resource indices that correspond to the second subset of the second set of reference signals; and
second differential measurements, relative to the absolute measurement, for each of the second subset of the second set of reference signals.

27. The network entity of claim 15, wherein the one or more processors are individually or collectively further operable to execute the code to cause the network entity to:
train a machine learning model configured to predict spatial-domain characteristics associated with the second set of reference signals based at least in part on at least the first measurement and at least the second measurement; and
select a downlink beam for communication with a user equipment (UE) based at least in part on an output of the machine learning model.

28. The network entity of claim 27, wherein the one or more processors are individually or collectively further operable to execute the code to cause the network entity to:
receive measurement information associated with at least a subset of the first set of reference signals;
input the measurement information into the machine learning model; and
obtain, as an output of the machine learning model, predicted spatial-domain characteristics associated with the second set of reference signals, wherein selecting the downlink beam is based at least in part on the predicted spatial-domain characteristics.

29. A method for wireless communications by a user equipment (UE), comprising:
receiving a control message that indicates, from a plurality of sets of resources associated with channel measurement, a first set of resources and a second set of resources, wherein the first set of resources corresponds to a first set of reference signals and the second set of resources corresponds to a second set of reference signals;
receiving one or more first reference signals of the first set of reference signals via the first set of resources and one or more second reference signals of the second set of reference signals via the second set of resources; and
transmitting a measurement report comprising at least a first measurement associated with at least one of the one or more first reference signals and at least a second measurement associated with at least one of the one or more second reference signals based at least in part on the control message and reception of the one or more first reference signals and the one or more second reference signals.

30. A method for wireless communications by a network entity, comprising:
transmitting a control message that indicates, from a plurality of sets of resources associated with channel measurement, a first set of resources and a second set of resources, wherein the first set of resources corresponds to a first set of reference signals and the second set of resources corresponds to a second set of reference signals;
transmitting the first set of reference signals via the first set of resources and the second set of reference signals via the second set of resources; and
receiving a measurement report comprising at least a first measurement associated with at least one of the first set of reference signals and at least a second measurement associated with at least one of the second set of reference signals based at least in part on the control message and transmission of the first set of reference signals and the second set of reference signals.
